(19) United States
(12) Patent Application Publication
(10) Pub. No.: US 2010/0138357 A1
(43) Pub. Date: Jun. 3, 2010

(54) TRADING SYSTEM

(75) Inventor: Hishaam Mufti-Bey, Hertfordshire (GB)

Correspondence Address: K&L GATES LLP, 210 SIXTH AVENUE, PITTSBURGH, PA, 15222-2613, US

(73) Assignee: Morgan Stanley (a Delaware corporation), New York, NY (US)

(21) Appl. No.: 12/327,575

(22) Filed: Dec. 3, 2008

(51) Int. Cl. G06Q 40/00

(52) U.S. Cl. 705/36 R; 705/37

(57) ABSTRACT

Systems and methods for facilitating trade idea utilization. In one embodiment, the method comprises creating a plurality of data grouping for new trade ideas, where each trade idea is associated with one or more financial products that are identified by an identifier in a financial product taxonomy. The trade idea is presented to an investor via a computer-based user interface. The investor may make the trade through the user interface.

### BACKGROUND

The present invention relates to a computer system for assisting in the trading of financial products.

The range of financial products or instruments that may be traded by investors, including individual investors and institutions, is vast. Swaps, options, futures and forwards may be traded on interest rate, cash or other derivatives listed on an exchange or agreed directly between two parties. Stocks, shares, bonds, foreign currency, commodities and other asset classes may also all be traded. Research analysts and traders, working independently or on behalf of financial advice and trading companies, analyse market data and trends, identify investment opportunities for these investors and propose trade ideas based upon these opportunities. Portfolio managers, traders and salespeople endorse particular ideas for investors who may decide to make the proposed trades or to develop their own ideas.

What is needed is a system which, in accordance with applicable law, can improve communication between all of these different parties to ensure that the best information about market trends and trade ideas is available to everyone and that trading based on ideas is more straightforward.

### SUMMARY

Aspects of the present invention provides a system and method of facilitating trade idea utilization. In one aspect, the method comprises: creating a plurality of data groupings for new trade ideas, where creation of a data grouping for a new trade idea comprises: displaying a new trade idea interface; entering trade idea description information; and associating the trade idea with one or more financial products, where each financial product is identified by an identifier in a financial product taxonomy; and presenting the trade idea, defined by the data grouping, to a user by a user interface. This aspect of the invention enables users of the trading system to easily navigate a user interface from a trade idea to a financial product and to quickly trade in the financial product or products proposed by the trade idea. The user interface may provide up-to-date price information for the one or more financial products that are updated at regular intervals or when a change in the price occurs, for example.

In one preferred embodiment, when a trade for a financial product is completed, information about the completed trade is stored that includes information about one or more of: the trade idea, a trader who created the trade idea, research on which the trade idea was based, and a research analyst who published the research. This enables the investors and other users of the trading system who completed the trade to easily locate related information about the completed trade, assisting them in confirming the worth of the trade or in identifying similar trades that could be made. Additionally, if new information about a trade becomes available, such as new research, this can be associated with the completed trade so that it can be quickly brought to the attention of the investor. Preferably the user interface provides two-way links between the different information sources to aid navigation.

Further aspects of the invention provide a system and method for facilitating selection of a financial product asset class. In one aspect, the system comprises: a storage device storing instructions adapted to be executed by a processor to generate a user interface, the user interface configured to display information relating to financial products and to receive a user selection of a financial product asset class; an input module configured to receive market data from a plurality of information sources, each information source providing market data for financial products in one or more asset classes; and a conversion module configured to convert the market data for the selected asset class into a format used by the user interface for use in displaying the information. This aspect of the invention aids a user in locating financial products that they wish to trade in different asset classes using a single user interface. Preferably, the user interface has interface elements that remain consistent across asset classes, but which provide different information content to the user depending upon the asset classes. A familiar, consistent interface aids navigation and improves the user experience.

Further aspects of the invention provide a system and method for use in trading financial products. In one aspect, the system comprises: a storage device storing: a plurality of investor accounts for use in accessing the system, each account associated with a different investor and identifying an importance measure of the investor to a financial trading company; and a plurality of trade ideas, each trade idea published by the financial trading company and proposing a trade to be made of one or more financial products; and instructions adapted to be executed by a processor to generate a user interface, the user interface configured to: receive a login of an investor; display one or more trade ideas selected from the plurality of trade ideas stored in the storage based upon the importance measure of the investor; and provide one or more communication options enabling the investor to contact a representative of the financial trading company based upon the importance measure of the investor. This aspect of the invention enables a financial trading company to provide different user experiences to different users and to reward loyal or important investors with an improved experience, including more proposed trade ideas and more communication options for contacting the financial trading company should the investor require assistance or guidance.

A further aspect of the present invention provides a system for facilitating the trade of financial products, comprising: a plurality of sources of market data, each source of market data providing information about a plurality of financial products and identifying each financial product with an identifier particular to that source of market data; instructions adapted to be executed by a processor to generate a user interface, the user interface capable of displaying a trading interface for use in trading a financial product and configured to receive a user input of an identifier for a financial product; a storage device storing information about each of a plurality of financial products, the information comprising each of the particular identifiers used for the financial product and data for creating a link to a trading interface for trading the financial product; and a conversion module in communication with the storage device for automatically converting the received user input of an identifier for a financial product into a link to the trading interface for trading the financial product. This aspect of the invention enables users to input financial product identifiers used by any one of a plurality of different market data sources into the user interface and to have that identifier converted into a link to a trading interface for immediately trading the financial product.

A further aspect of the present invention provides a system for facilitating access to documents, comprising: a storage device storing instructions adapted to be executed by a processor to generate a user interface, the user interface comprising: a plurality of regions, each region associated with a document, a size of a region representing an age of the associated document and a colour of a region representing either one of a popularity of the associated document and a relevance of the associated document to a user; a user interface element for selecting whether the colour of each region represents popularity or relevance; and a user interface element for selecting a start time and an end time of a timeframe, the user interface only displaying regions associated with documents published within that timeframe. This aspect of the invention provides users with a graphical representation of documents. Control over the presentation of the documents is provided which aids the user in locating a document of interest.

The above aspects of the invention and associated advantages have been provided as examples of the benefits of the present invention but should not be viewed as limiting. In addition to the systems and methods described above, the present invention may include computer program code stored on computer-readable media that, when executed by a processor, realises the same features of the invention.

### FIGURES

Embodiments of the present invention will now be described by way of an example only and with reference to the accompanying drawings in which:

FIG. 1 is an overview of a network in which the trading system operates;

FIG. 2 is an illustration of the information contained in user accounts of users of the trading system;

FIG. 3 depicts an Ideas interface screen;

FIG. 4 depicts a trade idea interface screen;

FIG. 5 depicts a prices interface screen;

FIG. 5a depicts an interface box for a price listing;

FIGS. 6 to 10 depict a series of new idea interface screens;

FIGS. 11 to 14 depict a Research interface screen;

FIG. 15 depicts a Blotter interface screen; and

FIG. 16 depicts a My Stack interface screen.

### DESCRIPTION

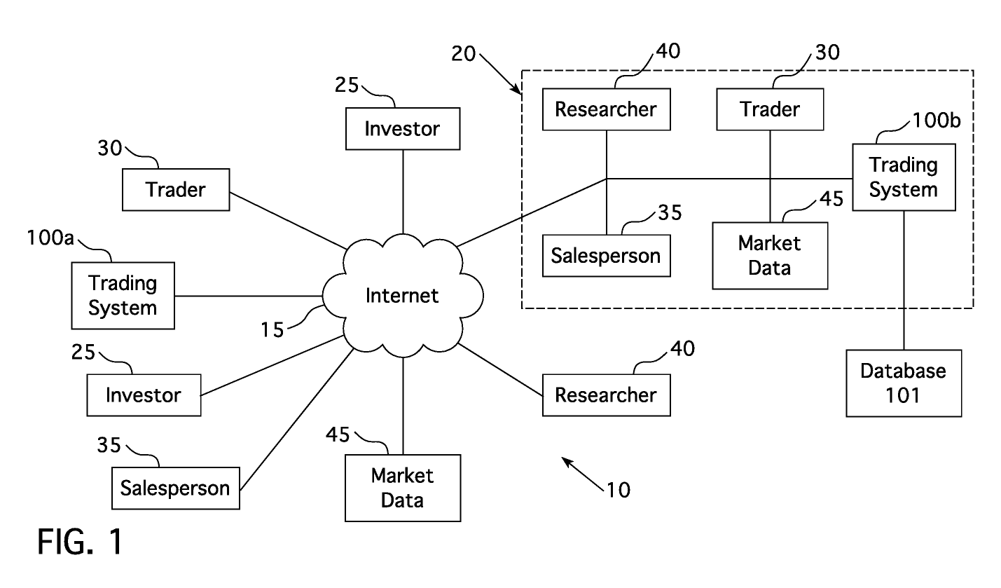

As illustrated in FIG. 1, a trading system 100 embodying the present invention operates in a network 10 that includes a public computer network 15 such as the Internet. Network users communicate with each other and with the trading system 100 over the public network 15. One or more private computer networks 20, such as Local Area Networks (LANs) or Wide Area Networks (WANs), may host a plurality of network users. Network users may include investors 25, traders 30, salespersons 35, and/or research analysts 40. The investors 25 may be individuals or corporations wishing to trade financial products. Traders 30 create trade ideas or proposals for products that investors 25 might wish to trade in. Salespeople 35 bring trade ideas to the attention of investors 25 and may carry out trades on behalf of investors 25. Research analysts (or researchers) 40, which may be economists, publish market research which may be used by traders 30 to develop trade ideas and by salespeople 35 or investors 25 to make trading decisions. These roles are not rigidly fixed since, for example, investors 25 may develop trade ideas themselves and traders 30 may bring their trade ideas directly to the attention of particular investors 25 rather than relying upon salespeople to promote their ideas.

The network 10 further includes one or more sources of market data 45 including information on tradable products and current price information for those products. The market data 45 may also comprise streamed news articles involving markets or geographic regions where products are listed or traded. Typically, there is a different source of market data 45 for different financial product asset classes such as commodities, foreign currency, and so forth. Each source of market data may use its own data structures to organise and distribute the information and its own taxonomies for classifying the products. Data from the market data sources 45 may be stored in a computer-based database system 101, a computer-based file system, or a search engine, or may be converted on-the-fly to a format suitable for presentation to users of the trading system. The database system 101 may also store account information for the various users, as further described below. In addition, the database system 101 may store data regarding the trade ideas, market research, and commentaries are described further below.

Within the trading system 100 each tradable product is identified by one or more names and/or codes. The trading system 100 preferably has its own internal taxonomy for identifying all products that are available for trade. Users of the system can use a name or code associated with a product by virtue of the internal taxonomy to identify the product to the system. The internal taxonomy forms part of a larger ontology or knowledge base of tradable products. The ontology provides additional information relating to the products such as the relationships between products, where market data about those products may be obtained, and the alternative data structures and taxonomies used by different data providers. The ontology is used to obtain the necessary market data and to convert the data from the structure used by the particular data provider to the structure used by the trading system 100. The ontology may also be used to recognise inputs from users identifying financial products using a known external taxonomy and to convert those inputs to the internal taxonomy to identify the same product.

The private network 20 may be managed by a financial advice and trading company. Such a company may employ its own traders 30, salespeople 35 and research analysts 40 in order to advise investors 25 that are clients of the trading company (“client investors”) and to carry out trades on their behalf. The financial advisor may also host its own source of market data 45 which may be derived from data received from external sources using the ontology.

A trading system 100 embodying the present invention comprises, and may be hosted by, a server computer system 100a connected directly to the public network 15, and/or a server computer system 100b on the private network 20 of the trading company. The server computer systems 100a, 100b may comprise one or a number of networked servers (e.g., a server farm). Each server system 100a, 100b may comprise one processor or two or more processors running operating systems such as Microsoft Windows, Linux, Unix, or MacOS, and each system may comprise numerous running processes, either single threaded or multi-threaded, that together comprise the logical trading system. When connected directly to the public network 15, the trading system 100 aids collaboration and trading between all network users. When the trading system is hosted by a trading company, the trading company can use the trading system to aid collaboration between their employees and to provide improved services to their client investors 25.

Providing users with access to the trading system 100 may be implemented in a number of different ways. A user may install a standalone application program onto their computer containing all of the necessary program code and supporting media such as sound and graphical items for generating a user interface and for communicating with the trading system server computer 100 to receive market data and other information. The application program may be downloaded from one of the server computer systems 100a, 100b or some other internet-connected computer or server (such as a content distribution network (CON)) over the Internet or installed from a computer readable medium such as a compact disc. Although such an implementation option has the potential to provide a powerful user experience, the application program may be large, impacting on the user's computer system performance. Any update to the application program must also be installed by each user individually and the difficulties inherent in doing this may result in different users using different versions of the application program, limiting the opportunities for developing the trading system.

A more flexible implementation option is to permit access to the trading system server computer system 100a, 100b through a browser program, such as a web browser, that is already installed (or readily obtained and installed) on each user's computer. In this implementation, the trading system server system 100a, 100b comprises a web server and transmits all user interface data and other information over the network 10 to each user on demand. Although this implementation option results in minimal impact on the user's computer system, it is limited by the functionality of the browser software and is unlikely to provide a satisfactory user experience.

Consequently, a preferred option is to provide access to the trading system by providing users with a small application program containing core instructions for generating a user interface and for communicating with the trading system server computer 100. The application is preferably a rich Internet application that is run through a web browser having a suitable plug-in such as Adobe Flash (RTM). Since the application program is small in size and preferably less than about five megabytes, it has reduced impact on the user's computer system, and a new version can easily be downloaded on demand. The application program may be stored on the trading system server or elsewhere on the public network 15 and users wishing to access the trading system are provided with linking or location information, such as a shortcut link that is stored on their computer, so that they can access the system as desired.

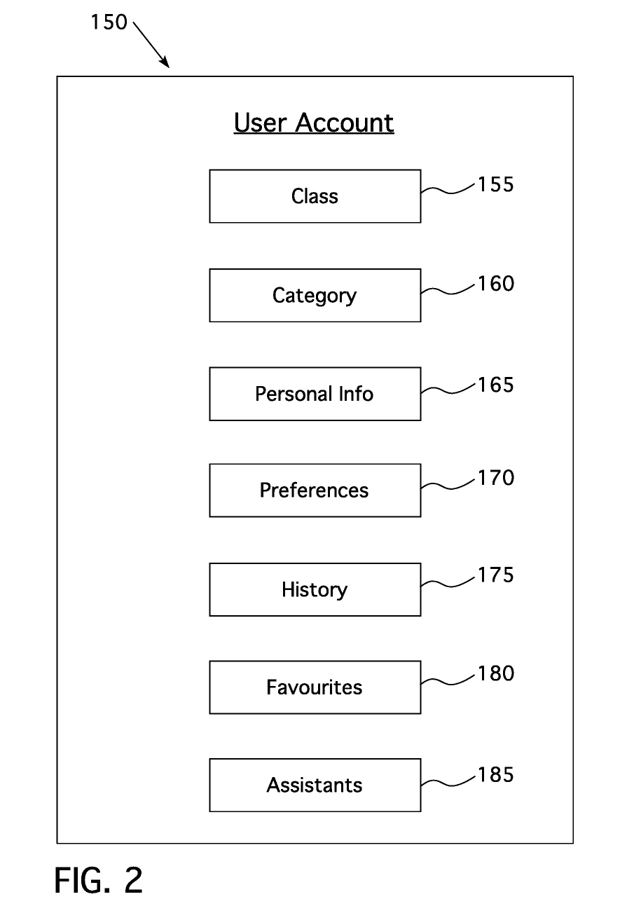

Each user of the trading system 100 has a user account which they use to access the trading system. User account information is stored in the database system 101 on the trading system or accessible by the trading system. FIG. 2 illustrates the types of information that can be stored in each user account 150. The class 155 of the user indicates the role of that user during trading such as, at a general level, investor 25, trader 30, salesperson 35 or research analyst 40. More specific classifications could indicate whether a user is a portfolio manager, quantitative analyst and so forth, or if the user is an administrative superuser able to perform actions that are unavailable to other users in order to ensure smooth operation of the trading system 100. The category 160 of the user further defines the position of the user within their respective class. For example, a trading company might wish to categorise client investors 25 according to their importance as a client while high-profile traders 30 or research analysts 40 can be categorised as such in their respective user accounts. The class 155 and category 160 information in the user account 150 is used by the trading system 100 to adjust the functionality that is available to individual users. For example, only research analysts 40 are permitted to publish research to the trading system 100 and only traders 30 are permitted to publish trade ideas although it is contemplated that other classes of users (e.g. salespeople or even individual investors) would be able to perform such actions if desired by the organisation hosting the trading system. In certain embodiments and subject to and in accordance with applicable law, the information that users can access or are presented with may also depend upon the class of the user viewing the information or the user who created the information. For example, in such an embodiment, some research or trade ideas may only be visible to high-importance client investors 25 while research and trade ideas published by high-profile research analysts and traders may be given more prominence within the trading system by highlighting it or by ensuring that it remains near the top of a list of similar items of information.

The user account also stores personal information 165 for users such as their personal name, contact information such as an electronic mail address and telephone number, and their login and password for accessing the system. The personal information 165 section may also store a user name used to identify them to other users, and a photograph or other image that is used as an avatar to represent the user within the trading system 100. Personal preferences 170 are stored indicating the user's preferences for using the trading system such as a list of other users they regularly engage or collaborate with (a “buddy list”) or preferences when trading such as preferred asset classes. Alternatively, the buddy list may be provided automatically to the user by the trading system 100 based on user-to-user coverage assignments made by logic contained therein. The preferences 170 section may also store information indicating what personal information 165 is made available to other users. The personal information and preferences are set and adjusted as desired by the user, typically based upon a default set of preferences. Some personal information and preferences may be required information, such as an e-mail address or another minimum amount of contact information, and other restrictions may be imposed on a user such as requiring that their user name be the same as their personal name for increased transparency or greater appearance of professionalism for employees of a trading company, for example. The trading system 100 may also monitor user behaviour and automatically adjust or propose adjustments to their preferences accordingly.

History information 175 is stored in the user account to maintain a record of past actions of the user including past trades for investors or salespeople and past trade ideas for traders, for example. This information is used to populate some sections of the system user interface, as described below. A favourites section 180 can store information or links to information in the system 100 including market research publications, trade ideas and other information selected by the user. Display of favourites in the trading system user interface is also described below.

The user account 150 also stores details of assistants 185 that have been assigned to a user to assist them in using the system 100. For example, a trading company may assign one or more salespeople or other assistants to a client investor 25 to represent the trading company and who the investor 25 can call on for help or advice in making a trade or performing any other action within the system 100.

A user wishing to access the trading system 100 clicks on, selects or otherwise activates the shortcut link to the application program for the trading system interface. The application is downloaded to the user's computer from the server system 100a, 100b (or retrieved from within the user's computer's download cache) and executed. If necessary, the user is prompted to install viewer or runtime software such as a browser plug-in or a new version of such software to enable execution of the application program. The user is then presented with a log-in screen at which they can enter their login and password to access the trading system. If a user does not yet have an account, information may be provided for creating one and this may involve online and offline correspondence between the user and the operator of the trading system to establish the user's identity, their credit worthiness if they are a potential investor and any other security checks that may be required by the trading system operator or by relevant laws.

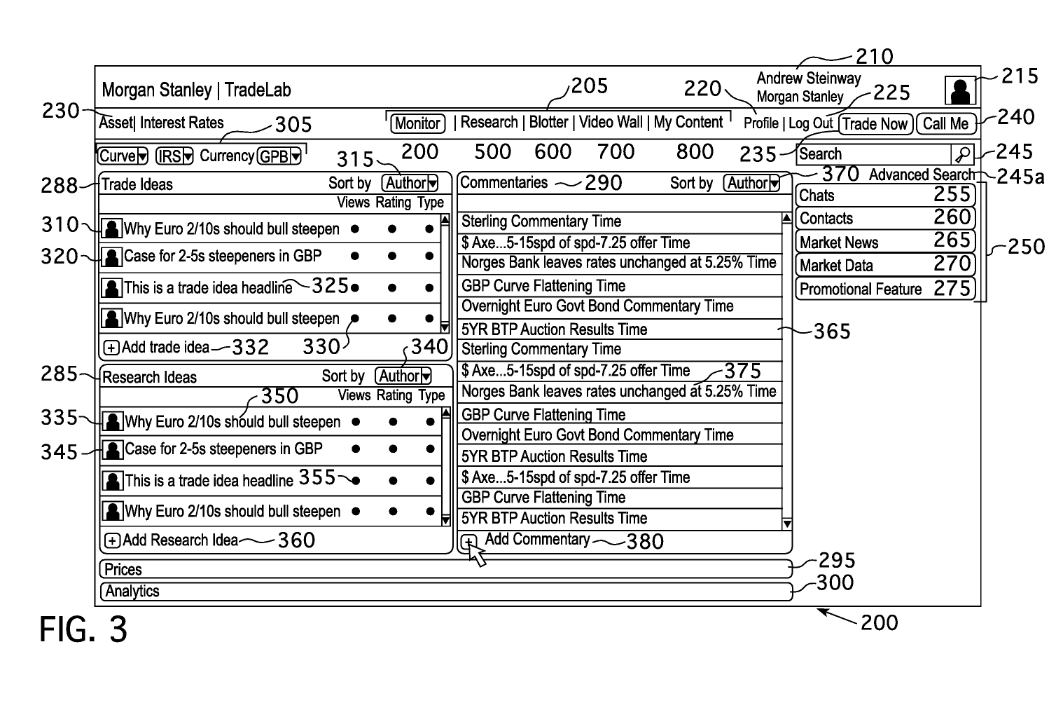

Once logged on to the trading system, the user is presented with a user interface screen such as the one shown in FIG. 3. The interface screen shown in FIG. 3 is an Ideas screen 200 at which a user can view trade and research ideas, price information and so forth. Other user interface screens including a Research screen 500, a Blotter screen 600, a Video Wall screen and a My Stack screen 800 can be accessed by clicking on the appropriate button or tab in a screen selection bar 205. The screen selection bar preferably is consistent across each of the user interface screens to aid the user in navigating the trading system interface. Other consistent interface items include a user identification 210, a user avatar 215, a profile button 220, a log-out button 225, an asset class indicator 230, a Trade Now button 235, a Call Me button 240, a search interface 245, and an interface menu 250.

The user identification 210 lists the user's user name and other information such as an organisation or user class 155 and indicates how the user will be identified to other users of the trading system. Similarly, the user avatar 215 indicates the avatar image that will be used to identify the user to other users. The user identification 210 or avatar 215 may be clicked by the user to directly change the displayed information or to select a new image or icon to use as an avatar and changes will be updated in the personal info 165 section of the user account 150. Alternatively, a user can click on the profile button 220 to access their user profile and change their personal info 165 and preferences 170 as desired. A user can log-out of the trading system by clicking the log-out button 225. For security reasons, a user may be logged out of the trading system automatically if they have been inactive for a predetermined period of time, such as 30 minutes.

The asset class indicator 230 identifies the asset class of the financial instruments that are currently viewable by the user through the user interface. On first logging into the trading system 100, the asset class may default to a preferred asset class identified in the preferences 170 section of the user account 150. Clicking on the asset class indicator 230 brings up a list of available asset classes and the user can select a new asset class to view. Information displayed in the user interface such as price information and trade ideas will change on selecting a new asset class to reflect the financial instruments that are available to trade under that asset class. A user can also define custom asset classes comprising combinations of two or more asset classes or any definable subset of one or more asset classes such as financial instruments relating to a particular commodity. Market data information for financial products in different asset classes will typically originate from different market data sources 45 and each market data source typically uses a different data structure to organise and distribute the market data.

A conversion module or abstraction layer receives market data for the selected asset class or classes and, using the ontology, converts it into a format suitable for presentation in the user interface that uses the names and/or codes used by the internal taxonomy for identifying different financial products. The conversion module may be implemented in any suitable programming language such as Java (RTM) and the conversion is preferably performed by the server system 100a, 100b hosting the trading system 100 and is transparent to the user. The software code of the conversion module may be stored on a computer readable medium, such as a memory chip or file system, of the server system 100a, 100b and is executed by the processor(s) of the server system 100a, 100b.

The Trade Now button 235 provides an easily accessible way for a user, such as an investor 25 or salesperson 35, to commence a trade on a financial instrument, assuming, for example, the investor 25 has permission to make the trade. The user interface provides many different ways to initiate trades and the process for doing so will be described below.

A Call Me button 240 allows a user to request a telephone call or other personal contact from a representative of the trading system operator. Typically, this button is made available for use by client investors 25 of a trading company hosting the trading system. When a client investor 25 or other user presses the Call Me button 240, a message is sent to one or more of the people listed in the assistants 185 section of the user's user profile 150 informing them that personal contact has been requested. The assistants specified would typically be employees of the trading company assigned to cover the client investor 25. If the assistants are logged into the trading system 100, this message may be an instant message that is displayed on their respective user interfaces. The message may indicate an urgency of the desired contact and indicate a mode for making the contact such as telephone, instant message or e-mail based upon the category 160 of the user who requested the contact. For example, for a high-importance client investor 25 of a trading company, the message may indicate that a telephone call, instant message or other real-time communication method should be used to contact the user within a short time period such as 10 minutes. For a less important client investor, the message may indicate that an e-mail sent within a longer time period, such as 2 hours would be sufficient. The message preferably includes contact information such as a telephone number or e-mail address extracted from the user account 150 and may include a button for initiating an instant messaging session with the user through the trading system user interface. If none of the assistants associated with the user are logged into the trading system 100, the trading system may automatically send an external message, such as an e-mail to one or more of the assistants notifying them of the request or may identify a different user to fulfil the “Call Me” request and send them a message through the trading system user interface. Again, the action taken may depend upon the category 160 of the requesting user. The trading system preferably keeps track of pending requests and prompts the assistant or assistants to attend to them within the allotted time frame and to indicate to the system when the requested contact has been made. Assistants that did not return the requested contact may then be notified that another assistant did reply to the request. Preferably the user who requested the contact is informed of the mode of communication and the time frame within which they can expect to receive a response to their request. The user may also be given the option to specify a preferred mode of contact or a particular telephone number or e-mail address at which they should be contacted if different from the information stored in the user account 150.

The search interface 245 operates to receive a search query from a user and to search for information contained within the trading system that matches that query. For example, a search may be made using the financial product names or codes of the internal taxonomy and the system locates trade ideas or financial product information matching the search query. If a search is made using a product name or code from a known external taxonomy, the ontology is used to convert the search term into the internal taxonomy to enable the search to take place. The scope of the search may depend upon the user interface screen that the user is viewing at the time. For example, a search performed while the user is viewing the Ideas screen 200 may be limited to information that is normally displayed on the Ideas screen such as trade ideas and financial instruments while a search performed from the Research screen 500 may be limited to published research and research analysts 40. More advanced searches may be made and preferred search options set by pressing an advanced searched button 245a.

The interface menu 250 provides a range of tools for a user to collaborate with other users or to obtain information. The interface menu 250 preferably operates as an accordion-style interface object in which the user selects a desired tool and the menu opens or expands to display the interface for that tool. Open interfaces for other tools in the interface menu 250 may close or minimise automatically or if there is insufficient room on the screen to display each of the active tools. The interface menu 250 therefore ensures that useful tools are always available to a user without cluttering the screen. Tools available through the interface menu 250 include a chats tools 255, a contacts tool 260, a market news tool 265, a market data tool 270 and a promotional feature tool 275.

The chats tool 255 provides an instant messaging interface enabling the user to communicate and collaborate with one or more other users through the trading system 100. Communication may be text based or, if the user's computer is equipped with a video camera, may be via a video link. Text messages entered into the system are analysed to identify names or codes from the internal taxonomy or a known external taxonomy associated with tradable financial products. When the system identifies such a name or code, the ontology is used to automatically convert the text into an active link to information about the financial product, enabling users to easily find a product that is being discussed and trade it, if desired. A chat session may be initiated by selecting a user from a buddy list stored in the favourites 180 section of the user's account 150, by searching for available users and selecting a user, or by selecting a chat option while viewing a user profile.

The contacts tool 260 provides a list of other users that are in the user's buddy list stored in the favourites 180 section of their user account 150. The list may also include assistants that have been assigned to the user in the assistants 185 section of their user account 150. Selecting a contact brings up an information screen or profile view providing additional information about that user extracted from their user account 150. The information screen may also include one or more communication options such as a button for initiating an instant messaging session with the selected user in the chats tool 255, a button for sending the user an e-mail, typically through an external e-mail program, and a button for requesting a telephone call, similar to the Call Me button 240 discussed above. The particular communications options available depend upon the class 155, category 160 and preferences 170 stored in the user accounts 150 of the user and the selected contact. For example, the selected user may have indicated in their preferences 170 that they do not wish to be contacted by e-mail. Also, investors 25 may be prevented from sending e-mails or requesting calls from traders 30 unless the investor is a high-importance client investor 25 of a trading company, for example.

The market news tool 265 provides news or links to news items about the market. The news items or links may be extracted automatically from one or more news sources and the particular news items displayed depend upon the selected asset class 230 and other user preferences. Similarly, the market data tool 270 provides market data or links to market data extracted from one or more sources based on the selected asset class 230 and user preferences.

The promotional feature tool 275 is used by the operator of the trading system 100 to bring information to the attention of users. The operator may create a number of different promotional features that are presented depending upon the selected asset class 230 and user preferences. If the operator is a trading company, the promotional feature tool 275 may be used to bring particular financial instruments or trade ideas to the attention of client investors 25 and salespeople 35. If the operator is merely hosting the trading system for use by individuals on the network 15, the promotional feature tool 275 may include paid adverts to provide the operator with a source of revenue.

The Ideas screen 200 preferably also includes a number of interface elements that are unique to that screen. These interface elements include a trade ideas interface 280, a research ideas interface 285, a commentaries interface 290, a prices interface 295, and an analytics interface 300. Preferably, these interface elements are gathered together in a space-efficient interface object, such as an accordion-style interface object, such that different interface elements can be expanded or minimised as desired. In the arrangement of FIG. 3, the trade ideas interface 280, research ideas interface 285 and commentaries interface 290 are in an expanded state while the prices interface 295 and analytics interface 300 are in a minimised state. The Ideas screen 200 also includes an options bar 305 for selecting viewing options such as the type of financial instrument (e.g., interest rate swaps) to display in each of the interface elements and the currency, for example.

The trade ideas interface 280 includes a list of trade ideas 310 that have been published by traders 30 or by any other class of user permitted by the trading system to do so. A trade idea is a proposal for a particular trade which the trader 30 or other user believes would be profitable or otherwise worthwhile. Trade ideas 310 in the list can be ordered by author, date, rating or any other suitable measure using a sort selection control 315. Each trade idea 310 may include the avatar 320 of the trader 30 who created or published the trade idea. Associating an image or a face with a trade idea helps build long term trust between the trader who published the idea and other users of the trading system. This is particularly important for investors 25 who may come to trust the proposals of particular traders 30. Each trade idea also includes a title or headline 325 indicating the trade being proposed and one or more other pieces of information 330 about the idea such as the number of times it has been viewed by users, a rating assigned to it by users and a type or category of the idea. An add trade idea button 332, which is only visible to or is only active for users of the appropriate class, such as traders 30, enables the creation and publication of a new trade idea.

The research ideas interface 285 includes a list of research ideas 335 that have been published by research analysts 40 or by any other class of user permitted by the trading system to do so. A research idea provides information about and analyses the market to suggest products that might be worth trading. Traders 30 will often use research ideas to develop trade ideas 310. Research ideas 335 in the list can be ordered by author, date, rating or any other suitable measure using a sort selection control 340. Each research idea 335 includes the avatar 345 of the research analyst 40 who created or published the research idea. Associating an image or a face with a research idea may help build long term trust between the research analyst who published the idea and other users of the trading system. In some embodiments, each research idea may also include a title or headline 350 indicating the research being discussed and one or more other pieces of information 355 about the idea such as the number of times it has been viewed by users and a type or category of the idea. An add research idea button 360, which is only visible to or is only active for users of the appropriate class, such as research analysts 40, enables the creation and publication of a new research idea.

The commentaries interface 290 includes a list of commentaries 365 that have been published by users of the system. Unlike trade ideas 310 and research ideas 335, any user may publish commentaries. A commentary is a remark or observation about trade ideas 310, research ideas 285 or any other aspect of the market that the commentator believes might be of value to other users. For example, a user may have identified a market trend that places doubt on a particular trade idea. As another example, a trader 30 may wish to promote one of their trade ideas 310 by highlighting a new research idea 335 that supports the value of the proposed trade. Commentaries 335 in the list can be ordered by author, date or any other suitable measure using a sort selection control 370. Each commentary also includes a title or headline 375 indicating the subject being discussed and the time the comment was published. An add commentary button 380, visible and active for all users, enables the creation and publication of a new commentary.

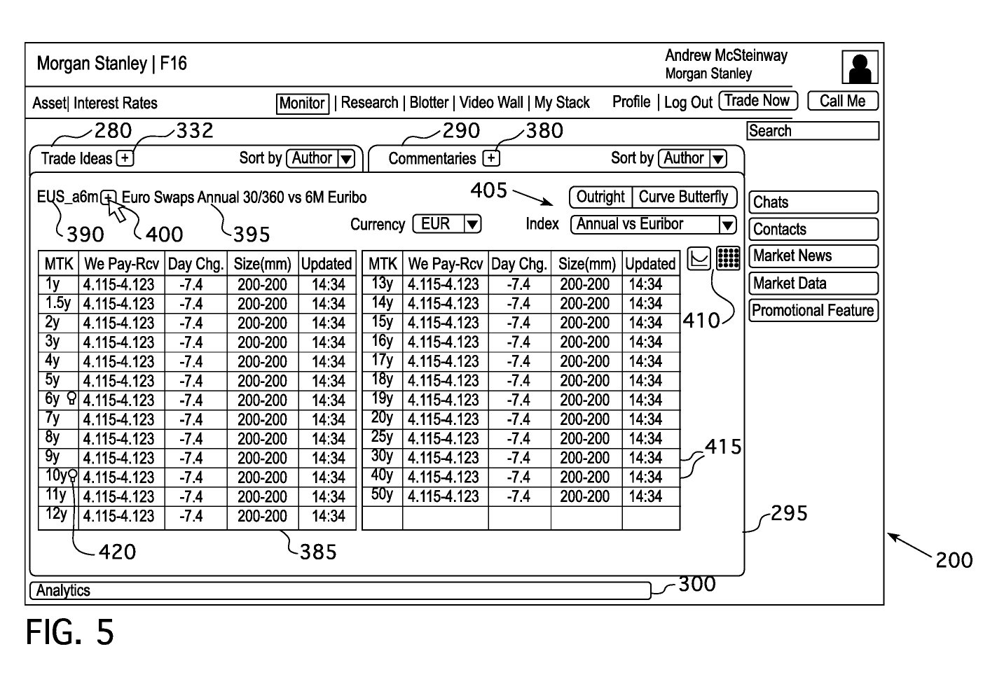

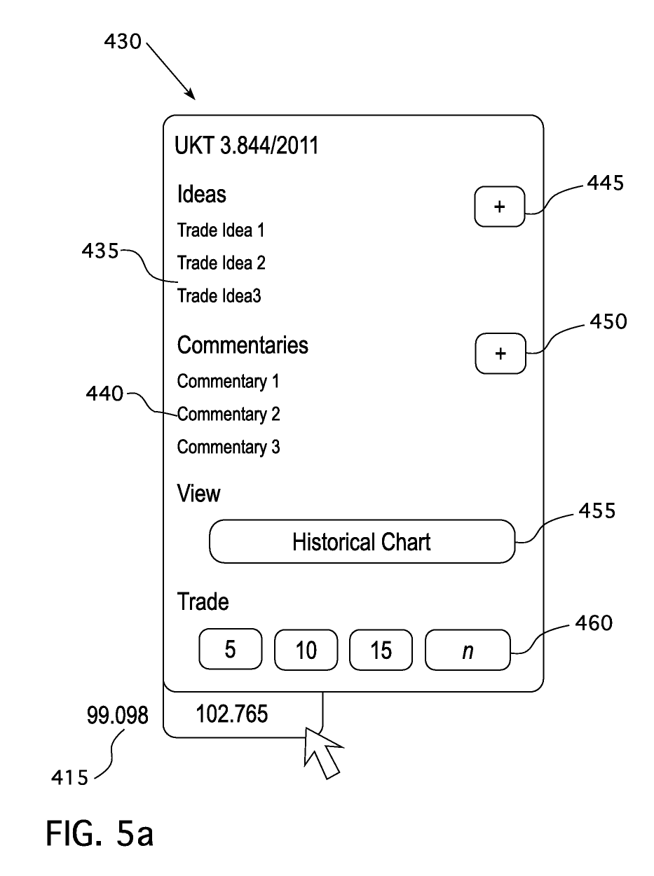

The prices interface 295 provides up to date price information for tradable products and is discussed below in connection with FIG. 5. The analytics interface 300 provides analytical information/tools and market data in a manner known in the state of the art. The prices interface and analytics interface 300 are preferably closed or minimised by default to save screen space and to avoid clutter in the interface. On opening the prices or analytics interfaces, the trade ideas interface 280, research ideas interface 285 and commentaries interface 290 are preferably closed or minimised in an accordion style.

From the above discussion of the Ideas screen 200, it will be recognised that in various embodiments related interfaces have been grouped together in two accordion-style interface objects. Other interface elements such as the asset class selector 230 and trade now button 235 may also be permanently accessible. These features of the Ideas screen 200 ensure that users can easily access all of the information necessary to find and research trade ideas and make trades in a wide range of different financial products from a single screen which nevertheless remains uncluttered. It will also be appreciated that almost all of the interface elements are active elements that can be clicked on or otherwise selected by the user to perform some action. This avoids wasted space in the interface and improves user-friendliness.

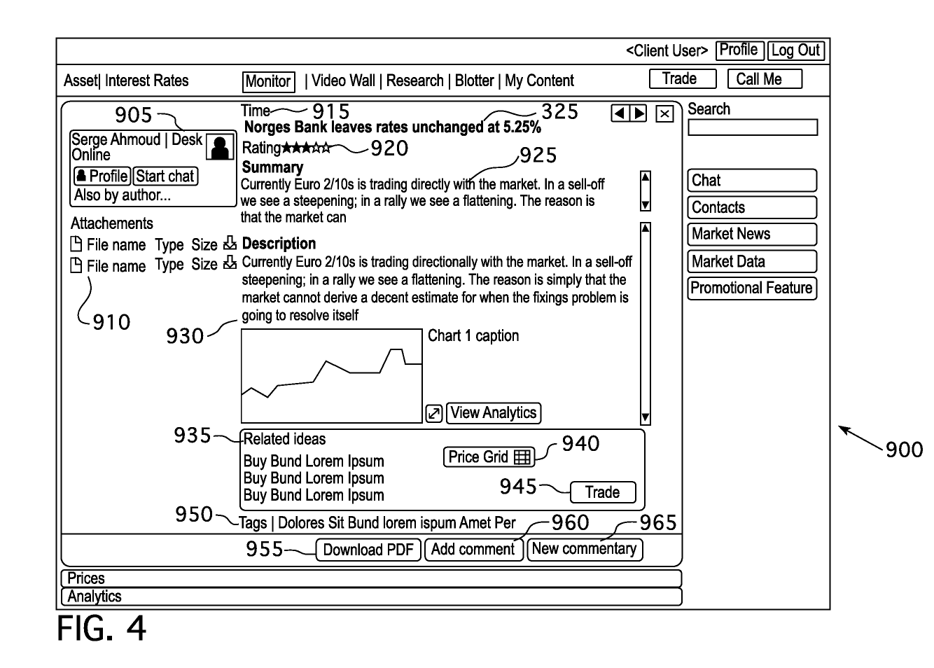

Returning to the trade ideas interface 280, clicking on a trade idea 310 in the interface brings up a trade idea view screen 900, as depicted in the example of FIG. 4. The trade idea view screen includes a trader profile view 905, an attachments list 910, a submission time 915, a title 325, a rating scale 920, a summary 925, a description 930, a related ideas list 935, a price grid button 940, a trade button 945, a tags list 950, a download button 955, a comment button 960 and an add commentary button 965.

The trader profile view 905 identifies the trader who created the idea being viewed with their user name or personal name and an avatar. A button to access additional profile information and a list of other ideas created by the same trader are also provided. As with the avatars in the list of trade ideas 310, these features of the profile view 905 help to ensure that a personal connection is made between traders 30 and investors 25 or other users and that long term trust can be built. The profile view may also include information indicating whether the trader is currently online and logged into the system and buttons to start an instant messaging session with the trader or to request some other form of communication depending upon the category and class of the user viewing the idea.

The attachments list 910 lists documents or files that the trader who created the idea has linked to or attached to the idea. These may be research documents that prompted the trader to propose the idea, market history reports providing additional history behind the proposed trade or any other documents that the trader believes are relevant to the idea and would be of interest or value to investors and other users when deciding whether or not to trade based on the idea. The attached documents may be documents that are internal to the system, such as research ideas that have been published to the system by research analysts 40. Alternatively, the attached documents may have been uploaded to the system by the trader when creating the idea. Users are able to view or download the attached documents to better understand the trade idea.

The submission time 915 indicates the time at which the idea was created and published to the system by the trader. This is useful since trade ideas are typically limited in time and an idea that was created a few days or even a few hours previously may no longer represent a worthwhile trade. On creating an idea, traders may indicate an expiry time after which the worth of the proposed trade may be in doubt or after which the trade may not even be possible. The expiry time may be specified in various ways (e.g., a specified duration after the submission time or a specified date). A display of the expiry time may be indicated with the submission time 915 or some other indication, such as a faded or alternative colouring for the idea, may be provided after the expiry time to let users know that the worth of the idea is now in doubt. Trade ideas with a firm expiry time may be deleted automatically by the system or otherwise made inactive after the expiry time.

The rating scale 920 indicates how users have rated the trade idea. Users may vote based on how worthwhile they believe the proposed trade would be, how successful the proposed trade has been after making it, or simply how well the idea has been explained and promoted by the trader. A vote can be cast by entering a numerical rating or by clicking on a desired point along the scale. For example, as indicated in FIG. 4, a user may select a rating of between 1 and 5 stars. The overall rating is assigned as an average of user votes and the votes of individual users may be weighted according to their category and class. The rating scale 920 may also permit users to leave more detailed comments about the idea as a way to provide feedback to the trader. Alternatively, or in addition, feedback may be left using the comment button 960.

The summary 925 summarises the trade idea and provides an introduction for an investor to understand the trade being proposed. The description 930 then provides a more detailed analysis of the proposed trade such as price charts, market history information and video or sound recordings to explain and promote the trade. This information may be interactive, enabling users to view different parts of a chart, for example, or actionable to provide links to other information sources. For example, the ontology may be used to automatically generate actionable links to financial product information from instances in the headline 325, summary 925 or description 930 of a product name or code from the internal taxonomy or a known external taxonomy. Files associated with charts, videos and other media items in the description may be listed in the attachments list 910 for ease of access.

The related ideas list 935 lists other trade ideas that are somehow related to the trade idea being viewed. These may be trade ideas that relate to the same or similar products or ideas by the same trader. Typically, the system will automatically identify related ideas 935. Alternatively, or in addition, the trader or other users of the system may manually suggest related ideas for inclusion in the list 935. The related ideas list 935 enables users to quickly and easily find similar trade ideas should they wish to compare a number of similar proposals or to make a number of similar trades. The related ideas list 935 may also identify related research ideas 335 if the trade idea is based upon one or more different research ideas.

The price grid button 940 enables users to view a list of products associated with or related to the particular product identified in the trade idea. For example, where the trade idea proposes a trade on a 6 year interest rate swap, the price grid button may bring up a list of interest swaps for other periods of time and the associated prices. An example of such a list is shown in FIG. 5 and will be described in more detail below. As with the related ideas list 935, the price grid button enables users to quickly and easily find similar trades to make comparisons or to trade in a range of similar products.

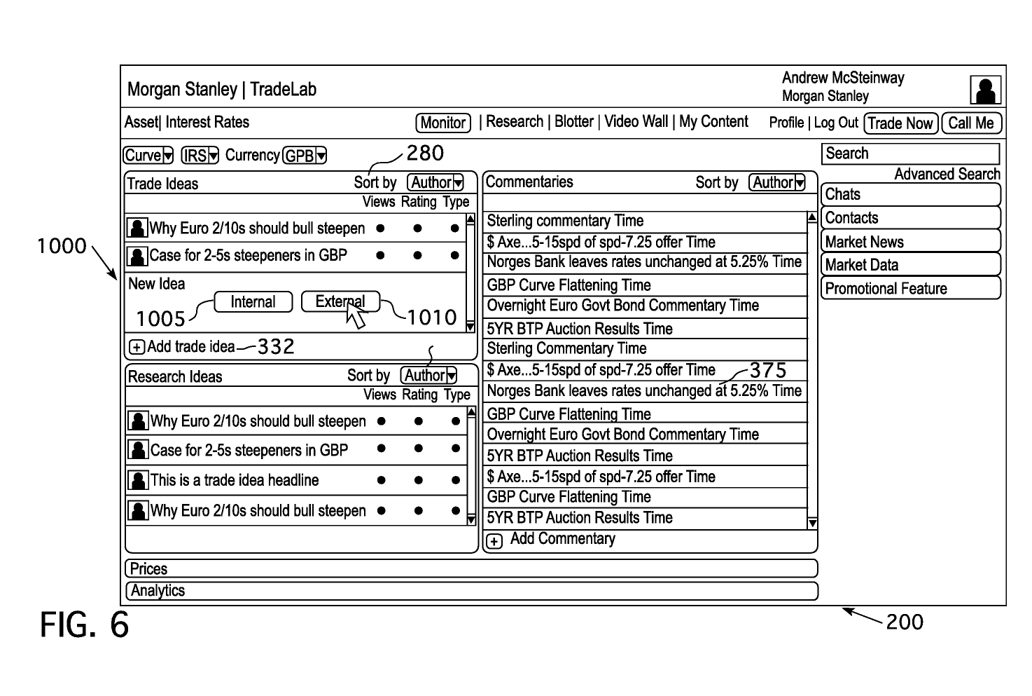

The trade button 945 enables investors 25 to immediately trade a product identified in the trade idea being viewed. This is achieved by linking or associating the trade idea with a particular product within the system, as will be described below in connection with FIGS. 6 to 10. Clicking the trade button 945 opens one or more additional user interfaces for receiving additional information about the trade, such as quantities desired, for requesting a quote and for confirming the trade. According to various embodiments, the system sends an electronic trade conformation(s) to the investor 25 when a trade for certain types of financial products has been executed.

The tags list 950 lists categorisation tags or meta information that have been associated with the trade idea. These tags may be added by the trader on creating the idea or later or may be added automatically by the system. Tags may indicate the asset class or some other feature of the product discussed in the trade idea, or may indicate the class of the trade idea and whether it is viewable by all users or only a subset such as high-value client investors 25. Tags aid in searching for trade ideas via the search interface 245.

The download button 955 enables a user to download a copy of the trade idea for subsequent viewing. The download is preferably in Portable Document Format (PDF) or some other widely supported and/or platform independent format. The add commentary button 965 permits the user to add a new commentary about the trade idea which will be visible to other users via the commentaries interface 290. A commentary created using this button automatically includes a link to the trade idea or includes some other identifying information so that the trade idea can be easily accessed by other users.

Returning to the research ideas interface 285 in FIG. 3, clicking on a research idea 335 in the interface brings up a research idea view screen (not shown). For consistency across the system, the research idea view screen is preferably laid out in a similar manner as the trade idea view screen 900 with elements such as a research analyst profile view, an attachments list, a submission time, a title, a summary, a description, a related research ideas list, a price grid button, a trade button, a tags list, a download button, a comment button and an add commentary button.

These interface elements operate in the same way as the corresponding interface elements in the trade idea view screen 900. For example, the research analyst profile view identifies the research analyst who published the research and may help to ensure that long term trust can be built between research analysts and other users of the system. The attachments list refers to documents relevant to or associated with the research idea. The submission time indicates the time at which the research idea was published and may indicate an expiry time. The rating scale indicates how users have rated the research idea with the option to leave feedback through the rating scale or by using the comment button. The summary summarises the research idea while the description provides a more detailed analysis with charts, video and other media that might be relevant. The related ideas list lists other research ideas that are somehow related to the research idea being viewed. If one or more trade ideas 310 have been created based upon the research idea, these may be included in the related ideas list to aid users in finding specific trade proposals that relate to the research idea. The download button enables a user to download a copy of the research idea for subsequent viewing. The add commentary button permits the user to add a new commentary about the research idea.

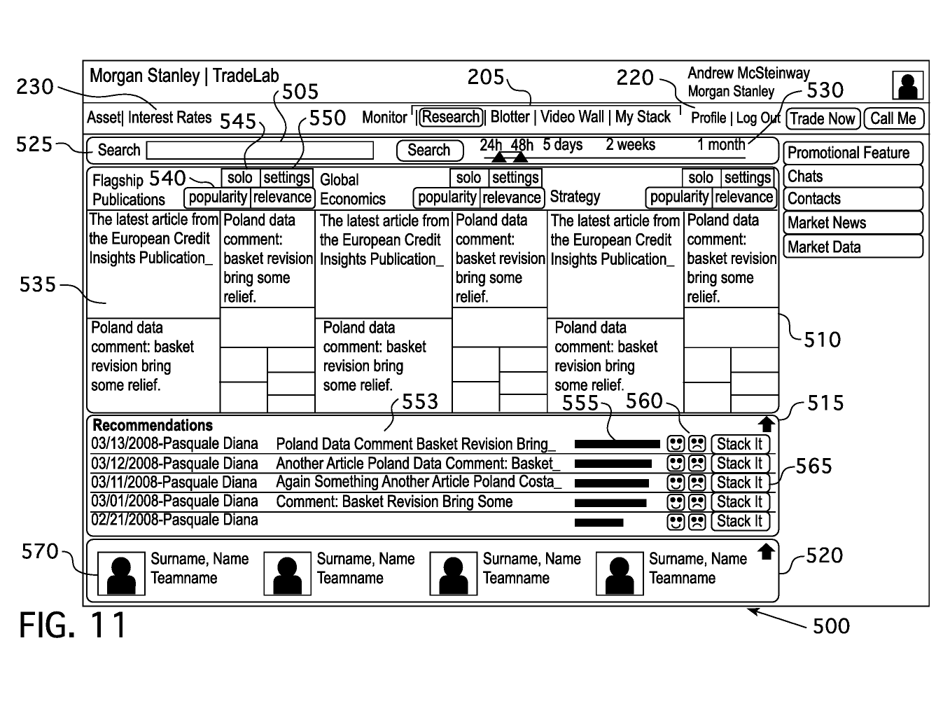

Unlike trade ideas 310, research ideas usually do not refer or relate to a single financial product but to a range of products. Nevertheless, one or more price grid buttons or trade buttons may be included to enable a user to easily view lists of prices or trade on products or product classes identified in the research idea. Alternatively, or in addition, a user may rely upon links automatically generated by the ontology from product names or codes in the title, summary and description to navigate to products of interest. As another option, where a trade idea has been created based upon a particular piece of research, the trade button may be replaced with a view research button enabling a user to easily access that research. Similarly, the price grid button may be replaced by a related research button to bring up a list of research that is associated with the research on which the research idea has been based, such as research by the same author or on the same topic. These items of research are displayed as part of the Research screen 500 illustrated in FIG. 11.

Returning to the commentaries interface 290 in FIG. 3, clicking on a commentary 365 in the interface brings up a commentary view screen (not shown). As with the trade idea and research idea view screens, the commentary view screen may include information about the user who published the commentary. However, since any user may publish commentaries, including investors and salespeople, there is less need to build personal relationships and trust with the author of the comment. The commentary may also include similar elements as the trade idea and research idea view screens such as attachments, a summary and a description. Typically, however, commentaries are much more brief than trade ideas or research ideas, do not propose any particular trade, and are more transient in nature such that the content of the commentary view screen is much reduced relative to the trade idea and research idea view screens.

Returning to the prices interface 295, clicking on the minimised interface as depicted in FIG. 3 expands the prices interface, as depicted in FIG. 5. Other expanded interface elements such as the trade ideas interface 280 and commentaries interface 290 are preferably minimised to make space for the prices 295 on a single screen. As shown in FIG. 5, however, the minimised trade ideas interface 280 includes an add trade idea button 332 to permit traders to easily create new trade ideas while viewing price information without having to expand the trade ideas interface 280. Similarly, the minimised commentaries interface 290 includes an add commentary button 380 for ease of access. In the example Ideas screen 200 shown in FIG. 5, the expanded prices interface 295 masks the research ideas interface 285 but this layout can be modified to suit the requirements and wishes of users. For example, if the user is a research analyst 40, the minimised trade ideas interface 280 may be automatically replaced with a minimised research ideas interface 285 having an add research idea button 360.

The prices interface 295 includes a price grid 385, a grid code 390, a grid name 395, a grid selector button 400, one or more grid options selectors 405, and a grid/graph toggle 410.

A price grid 385 is a list of financial products 415 that have been grouped together under a particular grid name 395, the grid name having a corresponding grid code or short code 390. The example in FIG. 5 shows a grid for a particular type of Euro swap and each listing 415 in the price grid 385 represents a different product with the term of the swap ranging from one year to fifty years. The generation and display of price grids is well known in the art. Improving on known price grids, the price grid shown in FIG. 5 additionally provides an idea identifier or icon 420. The idea icon 420 is included in or adjacent to listings 415 for a product having one or more published trade ideas 310 linking to or associated with it. A user is able to click on or select the idea icon 420 to open the associated trade idea 310. This aids users, and particularly investors 25 or salespeople 35 in identifying worthwhile trades and making those trades efficiently. If more than one trade idea is linked to or associated with a particular product this may be represented by providing a corresponding number of idea icons 420. Alternatively, clicking on, positioning or hovering the cursor or pointer over or otherwise activating a single idea icon may bring up a list of trade ideas associated with that product enabling the user to select a particular trade idea that they want to view. Icons or identifiers may also be provided for research ideas 335 or commentaries 365 that are linked to a particular product or products. This aids users in identifying products that are being discussed by others users of the system but is typically less useful when trading since research ideas and commentaries do not typically propose specific trades in the same way as trade ideas.

Clicking on or otherwise selecting a listing 415 brings up a price interface box or window 430, as illustrated in FIG. 5a. The price interface box 430 provides additional information about the price listing including a list of trade ideas associated with the listing 435 and a list of commentaries associated with the listing 440. An add trade idea button 445 enables a user to create a new trade idea associated with the particular financial product identified by the selected listing. Similarly, an add commentary button 450 enables a user to create a commentary associated with the particular financial product identified by the selected listing. These buttons may only be visible to or active for suitably authorised users. For example, the add trade idea button may only be visible to users who are traders. Research ideas and an associated add research idea button may also be provided, if desired. The price interface box 430 also includes an historical chart information button 455 for viewing market history information about the financial product and one or more trade buttons 460 enabling a user to trade in the financial product. Preferably, different trade buttons are provided that enable a user to immediately trade in a specific number (such as 5, 10 or 15) units of the financial product or to select an alternative number, n, units for trading. On activating one of the trade buttons 460, a request for quote ticket for the financial product is displayed and is automatically populated with the desired number of units.

A user can view a different price grid by selecting the grid code 390 and entering a new grid code for the price grid that they want to view. Alternatively, clicking on the grid selector button brings up a list of available grids and/or enables the user to search for a desired product. Each grid may have one or more different viewing options and these may be chosen by the user using the grid options selectors 405. The grid/graph toggle 410 permits the user to switch the view of the grid between the price grid 385 and a graphical representation such as a graph or other chart showing the price history or other information about the products listed in the grid. As with the listings 415 in the price grid 385, points on any displayed graphical representations that represent financial products may be selected or clicked on to bring up additional information about that product in order to initiate trading or to enable the creation of new trade ideas 310, research ideas 335 or commentaries 365.

Returning to FIG. 3, the add trade idea 332, add research idea 360 and add commentary 380 buttons enable users in the appropriate categories to create and publish new trade ideas 310, research ideas 335 and commentaries 365, respectively. The process for creating a new trade idea is illustrated in FIGS. 6 to 10.

When a user, typically a trader 30, clicks on or selects the add trade idea button 332 a new idea interface 1000 is opened. As depicted in the example of FIG. 6, this interface is initially opened within the trade ideas interface 280 and with a limited number of options in order to reduce the need to redraw the Ideas screen 200 and to avoid presenting too many new options to a user at one time. The new idea interface 1000 shown in FIG. 6 includes an internal idea button 1005 and an external idea button 1010. For a trading system 100 operated by a trading company, these buttons enable a trader 30 to choose whether the trade idea is to be published externally to users outside the trading company, such as client investors 25, or only internally to other traders 30, salespeople 25 and so forth employed by the trading company. Asking this question of the trader first ensures that the trader is in the correct frame of mind when creating the trade idea and takes an appropriately professional approach when creating an idea that is to be published externally.

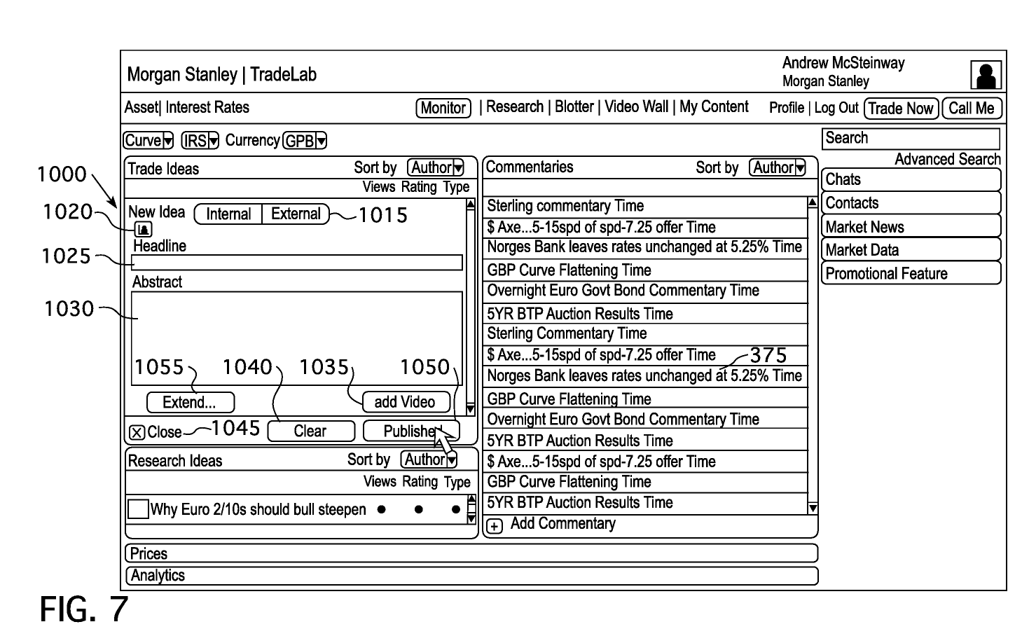

Clicking on either the internal idea button 1005 or the external idea button 1010 causes the new idea interface 1000 to expand as shown in the example of FIG. 7. The new idea interface 1000 in FIG. 7 includes an internal/external idea toggle 1015, a trade profile button 1020, a headline input area 1025, a summary input area 1030, an add video button 1035, a clear button 1040, a close button 1045, a publish button 1050 and an extend button 1055.

The internal/external idea toggle 1015 enables a trader to switch the publication status of the new idea from internal to external should the trader change their mind or have clicked on the wrong button in the new idea interface 1000 of FIG. 6. As shown in FIG. 7, the word “External” is emphasised to remind the trader of the publication status of the idea. The trader profile button 1020 enables a trader to check the details of their profile and ensure that they are correct before the trade idea is published and these details are made available to users viewing the trade idea. The headline input area 1025 and summary input area 1030 receive a title or headline 325 and summary 925 of the trade idea 310 respectively.

The add video button 1035 enables a trader to add a video to the idea. This may be an existing video file which has already been uploaded to the system or which the trader can upload or provide a link to. Preferably, however, the add video button 1035 enables a trader to record a new video file of themselves explaining their trade idea. Video may be recorded using a video recording device such as a webcam connected with the computer being used by the trader. Video information recorded by a trader 30 aids in the building of relationships and trust with that trader as well as providing more personal explanations of trade ideas for investors 25 and other users. In view of these benefits, a trading company may provide specialised equipment for traders such as computers or computer screens having camera hardware built-in to promote the use of video. As an alternative to recording a video, the trader may make an audio recording. A video or audio recording may be analysed by the system to automatically generate a transcript, converting spoken words to text, which can subsequently be used for searching purposes. Automatic speech recognition and transcription software forms part of the state of the art. The video and audio files may be stored in the database system 101, the file system, or a self-contained media storage and streaming service, such as Flash Media Server.

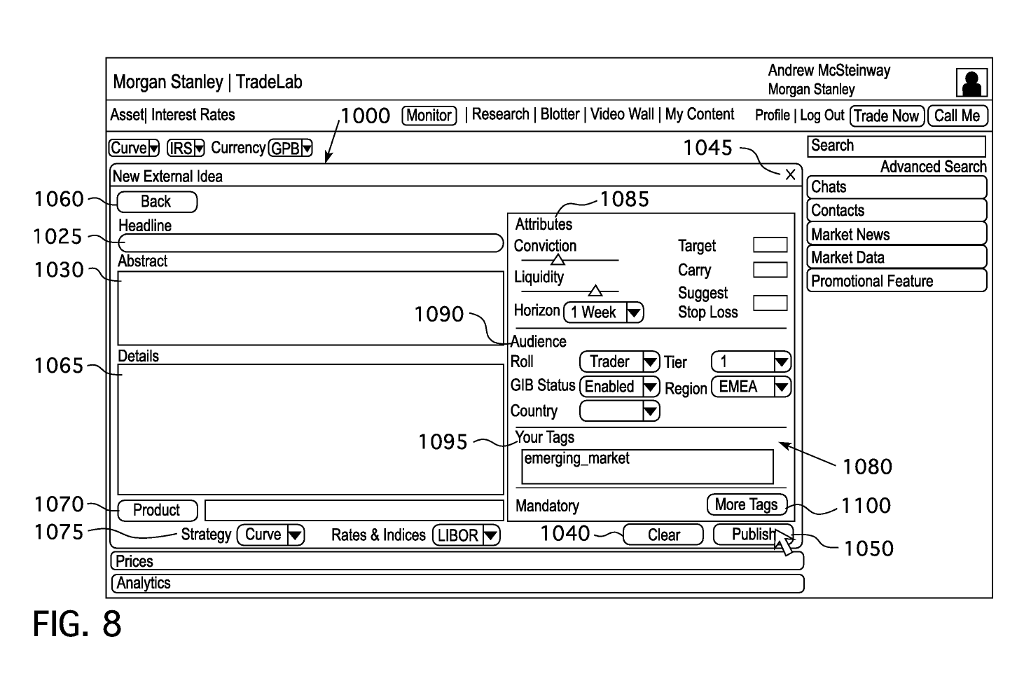

The clear button 1040 enables a trader to quickly clear information they have added such as the title, summary or video. The close button 1045 enables a trader to close the new idea interface 1000, cancelling the creation of the new idea. The publish button 1050 enables a trader to publish the trade idea to the system. An idea may be published with only a headline 325, a summary 925, and links to or the actual relevant disclosures. Preferably, however, before publishing an idea, a trader adds extended information by clicking the extend button 1055, which further expands the new idea interface 1000 as shown in the example of FIG. 8.

The extended new idea interface 1000 in FIG. 8 includes many of the same interface elements as in FIG. 7, including a headline input area 1025, summary input area 1030, clear button 1040, close button 1045, and publish button 1050. Additional interface elements include a back button 1060, a details input area 1065, a product input area 1070, one or more product options selectors 1075 and an extended information panel 1080.

Clicking the back button 1060 returns the new idea interface 1000 to the form shown in FIG. 7. The details input area 1065 receives a detailed description 930 of the trade idea.

The product input area 1070 receives identification information for the financial product to which the trade idea relates. A trader may use the product input area 1070 to select a product from a list or to enter a product name or code which is recognised by the system from either the internal taxonomy or a known external taxonomy. If the new idea has been created while the trader was viewing information about a particular financial product in the prices interface 295, the product input area 1070 is populated automatically with the correct identification information. The product input area 1070 may also be populated automatically if a product name or code has been entered into the headline input area 1025. Although entering product information is optional, doing so provides many benefits to the system as a whole including activation of the trade button 945 in the trade idea view screen 900 of FIG. 4 and the provision of idea identification icons 420 in the prices interface 295 of FIG. 5. When the idea is published, the link or association between the idea and the product is stored in a database along with the idea and used by the trading system to enable these advantageous features.

The product options selectors 1075 aid in the selection of products.

The extended information panel 1080 receives additional information about the trade idea which is used to classify the idea and to generate meta-information for searching purposes. Additional information may include attributes 1085 such as the trader's conviction in the idea or their assessment of liquidity. A likely time horizon or expiry time of the trade idea may also be entered. Audience information 1090 can be provided such as the role or class 155 of user that is permitted to view the idea and the tier or importance category 160 required by users within that role. Information about the region or regions and country or countries to which the idea relates may also be included. As indicated in FIG. 8, audience information 1090 is preferably mandatory to ensure that ideas are only visible to appropriate users. Each audience information field is preferably pre-populated with a default value so that an idea can be published without the trader having to manually provide the audience information each time they create a new idea. The default values may depend upon the category of the trader creating the idea or upon the trader's personal preference. A tags section in the extended information panel 1080 receives trader-defined tags to aid in classification of the idea. Tags may be entered completely at the discretion of the trader or the trader may be constrained to use tags selected from a standardised list.

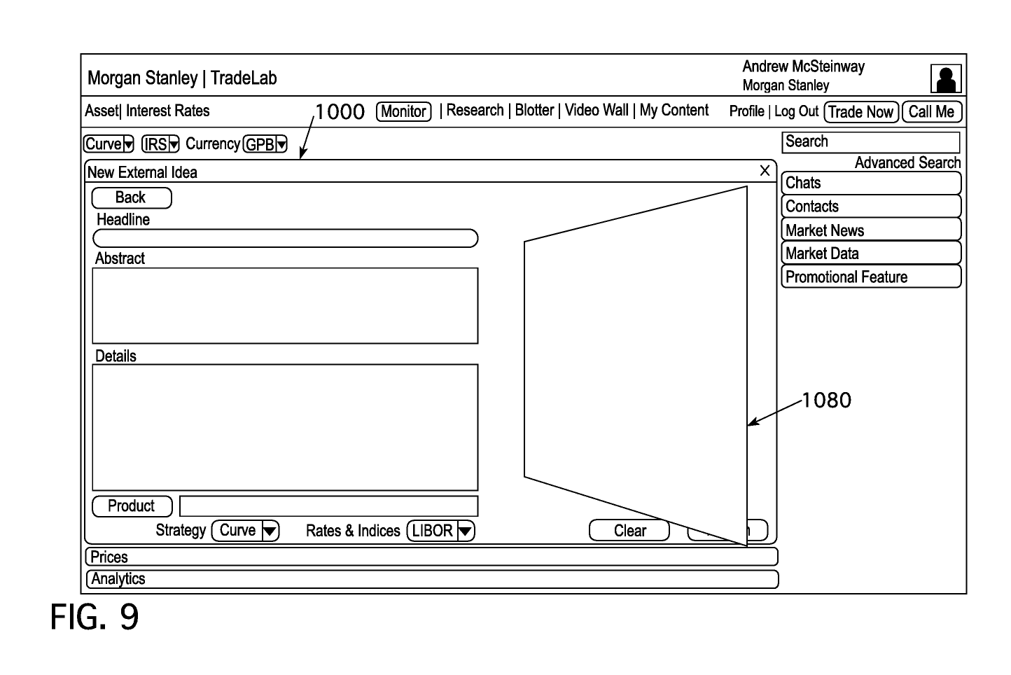

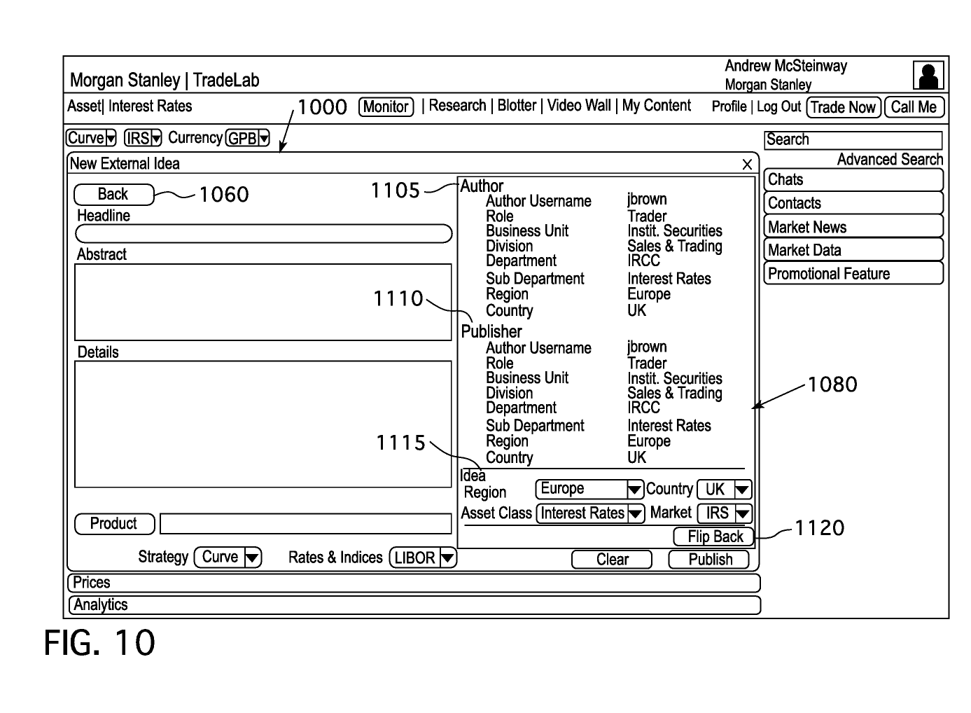

The extended information panel 1080 also includes a more tags button 1100. Clicking this button brings up more additional information fields for the trader to further classify the idea. Preferably, the transition from the set of information fields shown in FIG. 8 to the new set of information fields involves an animation suggestive of the information panel 1080 flipping over to reveal the new information fields on the back. The flipping animation is represented in FIG. 9 and the extended information panel 1080 following the transition is shown in FIG. 10. This transition avoids clutter and saves space in the user interface by replacing information fields that the trader has indicated are no longer required with alternative information fields rather than extending the new idea interface 1000 further. Simultaneously, the flipping animation provides the trader with an easily grasped representation of a two-sided panel which aids the trader in remembering the available options and their location within the interface.

The new information fields in FIG. 10 include author information 1105 and publisher information 1110 associated with the new trade idea. These fields are typically consistent for each trade idea published by a particular trade idea and will rarely require modification. Making these fields less accessible than other fields therefore does not reduce the ease of use of the new idea interface 1000 but minimises interface clutter. The new information fields also include a selection of key mandatory fields 1115 such as the region or country so that these can be updated if necessary without returning the extended information panel 1080 to its previous state. If necessary, however, a flip back button 1120 can be clicked to initiate a transition including a flipping animation back to the previous list of information fields.

Once a trader has completed all of the desired and/or required fields in the new idea interface 1000, the idea is published to the system by clicking the publish button 1050 and will be viewable by any user of the necessary class and category immediately. Instead of immediate publishing the workflow may include other steps prior to publication. These steps may include manual or automatic reviews or checks to ensure that the idea complies with legal requirements, quality assurance standards, acceptable risk factors and so forth. The relevant price grid or grids 385 in the prices interface 295 are also updated to indicate that a trade idea has been created that is associated with a product listed in that grid.

Although not illustrated in the figures, the procedures and associated interfaces for creating and publishing research ideas and commentaries are essentially the same as the procedures and interfaces for creating trade ideas described above.

The Research screen 500, shown in FIG. 11, is accessed by clicking on or selecting the Research tab in the screen selection bar 205. The Research screen 500 includes several of the same interface elements as the Ideas screen 200, including the profile button 220 and the asset class indicator 230. The user can adjust preferred display options for the Research screen 500 in their profile by using the profile button 220 and selection of an asset class also influences the information displayed.

The Research screen 500 includes a search interface 505, a publications interface 510, a recommendations interface 515 and an authors interface 520. These four interfaces elements may be grouped in an accordion-style interface object to aid navigation between the interfaces and to reduce screen clutter. In the arrangement of FIG. 11, the recommendations interface 515 and authors interface 520 are in a minimised state while the search interface 505 is illustrated in a state where no search has yet been conducted.

The search interface 505 includes a keyword search interface 525 and a search timeframe selector 530. The keyword search interface 525 receives an entry of one or more search terms and locates research items stored in the database system 101 that match those search terms. Matching research items may be displayed by expanding the search interface 505 or in the publications interface 510. The search timeframe selector 530 enables a user to select a start time and an end time of a timeframe within which the research was published. The timeframe may be set before a keyword search is performed so that the desired research is located on performing the search. If the timeframe is adjusted after performing a search, the information displayed in the expanded search interface 505 or in the publications interface 510 is updated accordingly.

The publications interface 510 includes one or more publication lists 535 and, associated with each publication list 535, a popularity/relevance toggle 540, a hide others button 545 and a settings button 550.

Each publication list 535 is a categorised list of one or more research documents. Example categories include the publisher of the research, such as an individual research analyst 40 or an organisation, a topic of the research, a region or country to which the research relates and so forth. The same research may be present in more than one category. The example list in FIG. 11 displays three categories: Flagship Publications, Global Economics, and Strategy. The Flagship Publications category includes research published by a select group of publishers while the Global Economics and Strategy categories include research related to those topics. Research documents within each publication list 535 may be arranged in a treemap. In other words, within a publication list 535, each research document has a display region containing identification information for the document such as a title, author or research analyst 40, publication organisation, publication date as so forth. The display region is typically rectangular and the size of the display region represents the age of the research document, with newer documents having a larger display region. Furthermore, the position of the display region within the list may indicate the age of the document, with newer documents located in the top left of the publication list 535 and older documents located in the bottom right of the list. This ensures that a user can quickly identify the newest research. The display region may also be colour coded to represent either the popularity of the research document or the relevance of the research to the user. Relevance may be determined based on any or all of user profile options, selected asset class, a search performed by the user using the search interface 505, previously viewed research and so forth. Popularity may be based on any or all of user votes, the number of times the research has been viewed or saved, the number of research ideas linking to the research and so forth. A choice of whether the colour coding of the regions is performed based on popularity or relevance is made using the popularity/relevance toggle 540. Since the size and location of the display regions are based on the age of the associated research document, a user can toggle between popularity and relevance views without losing track of the position of any research documents. The colour coding provides an additional, easily perceived level or dimension of information about each research document. Preferably, each publication list 535 displayed in the publication interface 510 has an associated colour and the popularity/relevance of the individual documents is indicated by using different shades of that colour. For example, the most relevant/popular document may be displayed in a vibrant shade of the colour for that category while less popular/relevant documents use a progressively paler shade. This ensures that different publication lists are easily distinguishable from one another and that the user is not required to learn a particular colour scheme.

The hide others or solo button 545 hides any other displayed publication lists 535 and the selected publication list is expanded to fill the available space. Clicking the hide others button 545 a second time returns the view to its previous state.

The settings button 550 enables a user to choose settings for the publication list 535 such as the publication category to display, the colour scheme to use based on popularity/relevance, size and location options based on age, filter options for research documents for assessing relevance and so forth.

A research document in a publication list 535 can be viewed by clicking or double-clicking on it. Preferably, a single click brings up a short summary or abstract for the document while a double-click opens the document fully. The full view of the research document includes profile information for the author of the research document to build trust between users and authors and controls for voting on the research which will affect the research's popularity. The full view may also include any or all of an add trade idea button, an add research idea button, and an add commentary button. If a trade idea, research idea or commentary is created using one of these buttons, the system automatically creates a link to the associated research document or attaches the document.

The recommendations interface 515 includes a list of articles that might be of interest to the user. The list is generated automatically by the system based on any or all of user profile options, age of the document, current and previous searches, previously viewed research and so forth. Each document in the list includes document information 553, a relevance score 555, a relevance confirmation control 560 and an add to stack button 565. The document information 553 includes information about the research document such as the title, publication date and author, and can be clicked or selected to open the associated research document. The relevance score 555 indicates the automatically determined relevance of the document to the user and, by default, the list is sorted by relevance. The relevance confirmation control 560 enables the user to indicate whether the document is relevant to them or not. User input to this control is saved to the user's profile options and used to improve future recommendations. The add to stack button 565 enables a user to save the recommended document to their “stack” for later viewing via the My Stack screen 800. Expanding or maximising the recommendations interface 515 reveals a longer list of recommended documents, access to user options, and controls for changing the default sorting property to properties such as the age of the document or the author of the document, for example.

The authors interface 520 includes one or more author icons 570. Author icons included in the list may be automatically selected by the system based on user profile options, past searches or viewing habits and so forth, or may be manually chosen by the user. Each author icon 570 includes an avatar for the author and information such as their name. Clicking on an icon brings up more information about the author including their publications. The authors interface 520 therefore enables users to easily locate new publications by their favourite authors.

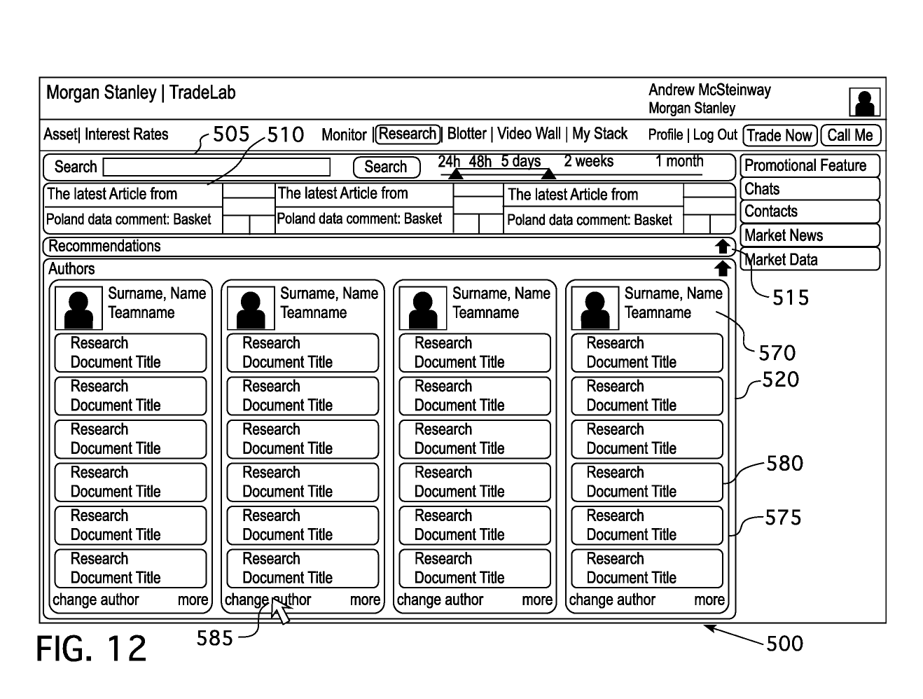

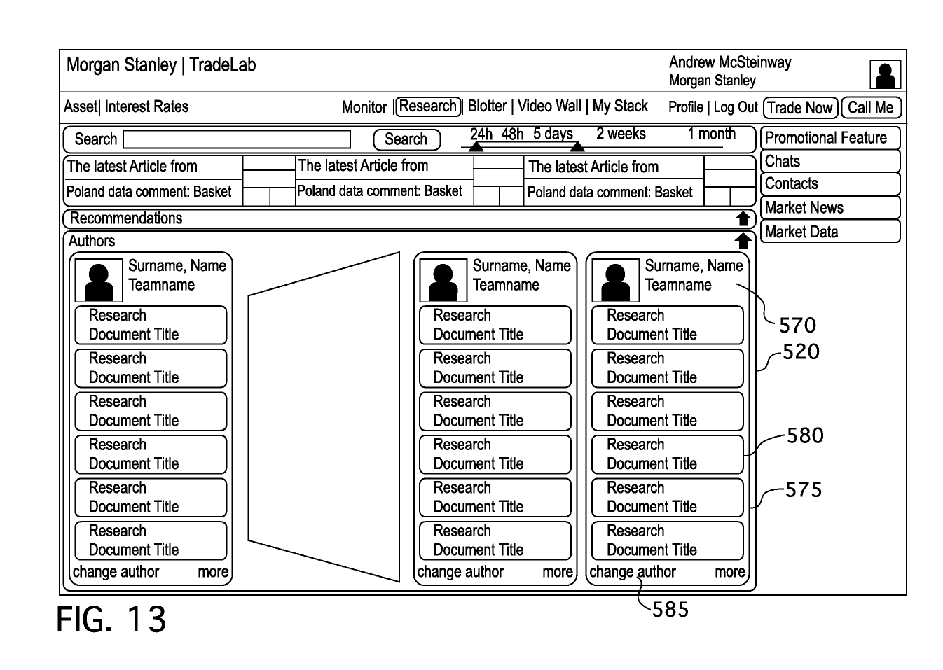

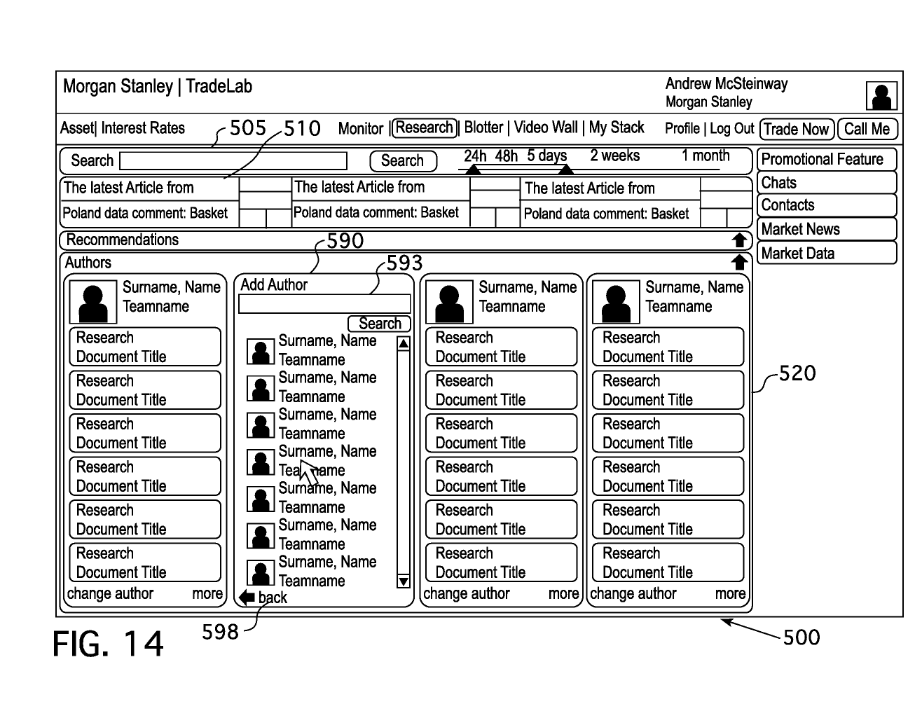

The expanded authors interface 520 is shown in the examples of FIGS. 12 to 14. As shown in FIG. 12, in the expanded authors interface 520, each author icon 570 is incorporated into an author panel 575 that includes a list of research documents 580 published by the associated author. The author panel also includes a change author button 585. Clicking on the change author button 585 initiates an animated transition, illustrated in FIG. 13, of the selected author panel 575 flipping over to reveal a select author panel 590 as shown in FIG. 14. Replacing the contents of the author panel 575 (which the user has indicated is no longer of interest to them having clicked on the change author button 585) with the select author panel 590 saves space in the authors interface 520.

The select author panel 590 includes a search interface 593, an author list 596 and a back button 598. The search interface 593 enables a user to search for a new author by entering search terms such as an author name, a publishing organisation or a research document previously published by the author. The author list 596 includes a list of authors and the associated avatars. The list may initially include all authors arranged alphabetically and can be filtered by using the search interface 593 or based on profile options such as a list of favourite authors. When the user selects an author from the author list 596, the select author panel 590 reverts or flips back to the author panel 570 which displays the information for the newly selected author. The user can also return to the author panel 570 without changing the author by using the back button 598.

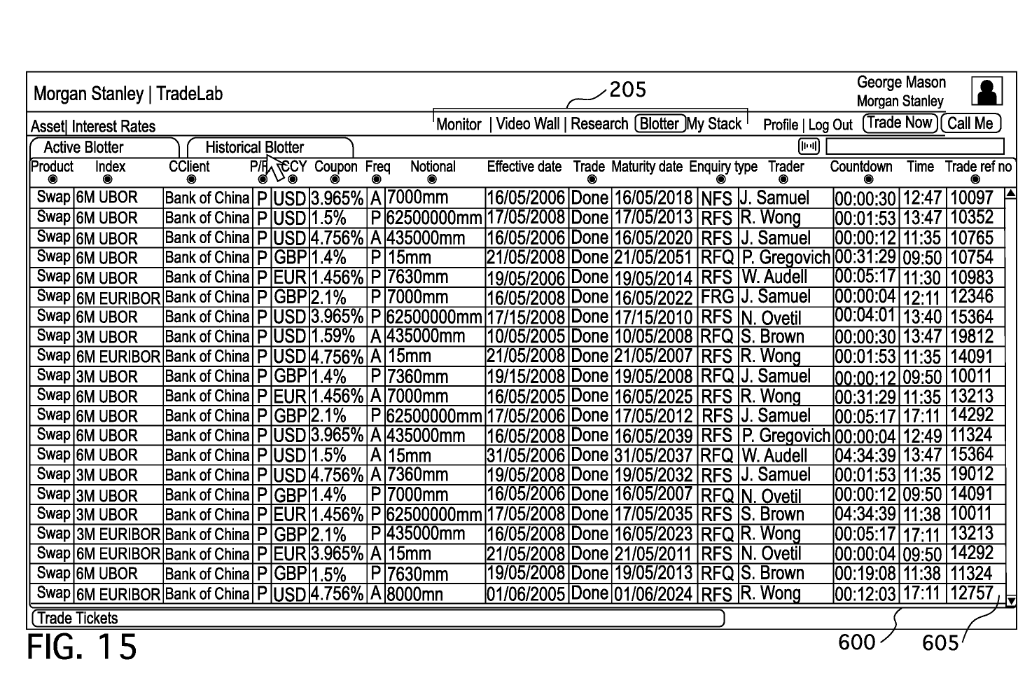

The Blotter screen 600, shown in FIG. 15, is viewed by the user by selecting the Blotter tab from the screen selection bar 205. For investors 25 and salespeople 35, the Blotter screen 600 includes a list of past trades 605 and is well known in the state of the art. The system 100 in one embodiment provides an improved Blotter screen with useful functionality for traders 30 and research analysts 40 and additional functions for investors 25 and salespeople 35. These additional features arise from the links within the system between trade ideas, research ideas, commentaries, research and products and the ability of the system to create new links.

When a trade is made based on a particular trade idea, by using the trade button 945 shown in FIG. 4, for example, this is recorded by the system and a link between the trade and the trade idea is stored. This link is two-way in that it can be followed from the trade to locate the associated trade idea or from the trade idea to locate the associated trade. Links from the trade idea to other information in the system are also stored, such as links to research ideas or research on which the trade idea was based. The links may be stored in a database of the database system 101.

This is useful from the perspective of a trader 30 since their Blotter screen 600 can be populated with a list of trades that have been made by other users based upon trade ideas published by that trader. Full details of the trade may not be made available to the trader for reasons such as compliance with securities laws and regulations, trading policies, security policies and so forth. Nevertheless, this is useful for a trader 30 in identifying which of their ideas have proved of interest to investors and may also be used in determining bonuses paid to the trader 30 by a trading company. Similarly, in certain embodiments, and subject to and in accordance with applicable law, a research analyst 40 may be able to use their Blotter screen 600 to view trades that have been made by other users based upon trade ideas published by traders that were themselves based upon research ideas published by that research analyst. In such an embodiment, both traders and research analysts may be able to see the impact of their work on trading, potentially motivating them and helping them to develop their skills.

From the perspective of an investor 25 or salesperson 35, maintaining the link between a trade and the originating trade idea or research idea enables the investor or salesperson to follow up on a particular trade. Commentaries published to the system after making the trade and which link to the trade idea or research idea associated with the trade can be brought to the attention of the investor/salesperson automatically. Such commentaries may bring new research or information to light indicating that the trade was not advisable. The investor/salesperson is then able to reverse the trade, if desired, without delay. Conversely, new information may indicate that the trade was worthwhile, giving extra confidence to the investor/salesperson.

Associating new research or information with a past trade can also be done manually. Typically, this will be done by a salesperson 35 working for a trading company on behalf of a client investor 25. If the salesperson locates new research relating to a particular trade that they have made on behalf of a client investor, they can update the trade in the Blotter screen 600 to link to that research.

The Video Wall screen (not shown) is viewed by the user by selecting the Video Wall tab from the screen selection bar 205. The Video Wall provides a single location at which users can locate and view videos files relating to market information. Videos may include live feeds or archived recordings from news channels, videos recorded by a trader or research analyst when creating a trade or research idea, respectively or any other video information available to the system. Traders and research analysts may also create new trade ideas and research ideas based on particular videos and a link to the video is then automatically associated with the trade/research idea. Archived videos may be automatically transcribed to enable text-based searching.

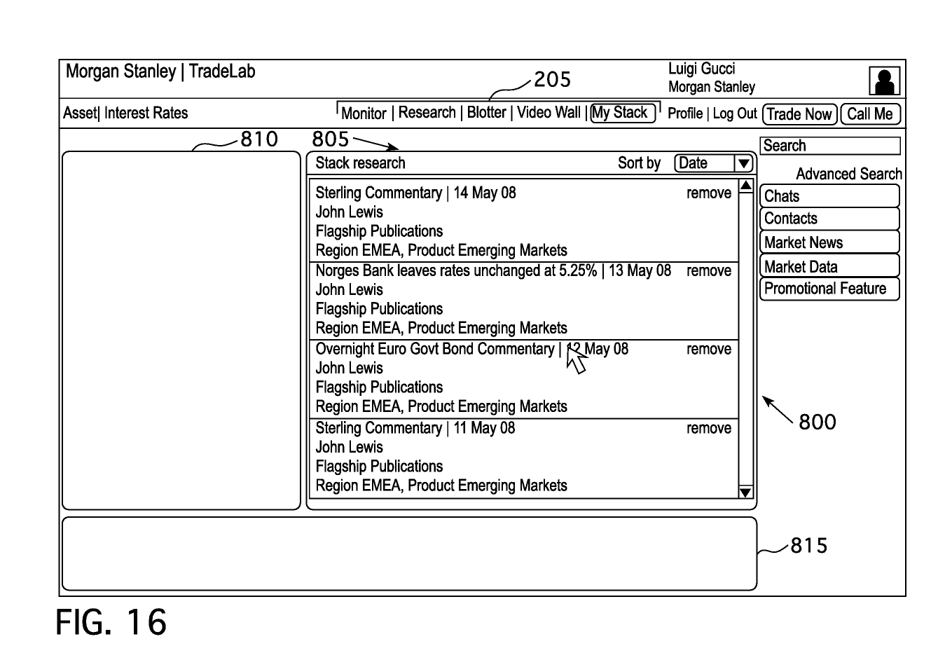

The My Stack screen 800, shown in FIG. 16, is viewed by the user by selecting the My Stack tab from the screen selection bar 205. The My Stack screen 800 lists individual items of information which the user has saved for subsequent viewing. Each item has an associated type such as research documents, trade ideas, research ideas and so forth. Within the My Stack screen 800, each type of information has a different panel or region where the associated saved items are displayed. For example, a research document may be saved to the stack by using the add to stack button 565 shown in FIG. 11 and can later be retrieved from the stacked research panel 805 of the My Stack screen 800. The stack also includes regions that are automatically updated to display documents published by the user 810 and publications recently viewed by the user 815.

As used herein, a “module” may be considered a computer software code stored as a series of instructions or commands on a computer-readable medium that, when executed by a processor(s), caused to processor(s) to perform the described function of the module.

The examples presented herein are intended to illustrate potential and specific implementations of the embodiments. It can be appreciated that the examples are intended primarily for purposes of illustration for those skilled in the art. No particular aspect or aspects of the examples is/are intended to limit the scope of the described embodiments.

It is to be understood that the figures and descriptions of the embodiments have been simplified to illustrate elements that are relevant for a clear understanding of the embodiments, while eliminating, for purposes of clarity, other elements. For example, certain operating system details and modules of network platforms are not described herein. Those of ordinary skill in the art will recognize, however, that these and other elements may be desirable in a typical processor or computer system. However, because such elements are well known in the art and because they do not facilitate a better understanding of the embodiments, a discussion of such elements is not provided herein.

In general, it will be apparent to one of ordinary skill in the art that at least some of the embodiments described herein may be implemented in many different embodiments of software, firmware and/or hardware. The software and firmware code may be executed by a processor or any other similar computing device. The software code or specialized control hardware which may be used to implement embodiments is not limiting. For example, embodiments described herein may be implemented in computer software using any suitable computer software language type, such as, for example, Java, C or C++ using, for example, conventional or object-oriented techniques. Such software may be stored on any type of suitable computer-readable medium or media, such as, for example, a magnetic or optical storage medium. The operation and behavior of the embodiments may be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes associated with the present embodiments may be executed by programmable equipment, such as computers or computer systems and/or processors. Software that may cause programmable equipment to execute processes may be stored in any storage device, such as, for example, a computer system (non-volatile) memory, an optical disk, magnetic tape, or magnetic disk. Furthermore, at least some of the processes may be programmed when the computer system is manufactured or stored on various types of computer-readable media. Such media may include any of the forms listed above with respect to storage devices and/or, for example, a modulated carrier wave, to convey instructions that may be read, demodulated/decoded, or executed by a computer or computer system.

It can also be appreciated that certain process aspects described herein may be performed using instructions stored on a computer-readable medium or media that direct a computer system to perform the process steps. A computer-readable medium may include, for example, memory devices such as diskettes, compact discs (CDs), digital versatile discs (DVDs), optical disk drives, or hard disk drives. A computer-readable medium may also include memory storage that is physical, virtual, permanent, temporary, semi-permanent and/or semi-temporary.

A “computer,” “computer (or server) system,” “host,” or “processor” may be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein may include memory for storing certain software applications used in obtaining, processing and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable media.

In various embodiments disclosed herein, a single component may be replaced by multiple components and multiple components may be replaced by a single component to perform a given function or functions. Except where such substitution would not be operative, such substitution is within the intended scope of the embodiments. Any servers described herein, for example, may be replaced by a “server farm” or other grouping of networked servers that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand and/or providing backup contingency in the event of component failure or reduction in operability.

Embodiments of the present invention have been described using detailed examples and with reference to features and functionality that it is believed would be preferred by the majority of the users of the trading system. It will be understood, however, that the present invention is not limited except by the appended claims.

What is claimed is:

1. A computer-implemented method of facilitating trade idea utilization comprising:
creating, using a computer system, a plurality of data groupings for new trade ideas, wherein data regarding the new trade ideas are stored in a database system associated with the computer system, wherein creation of a data grouping for a new trade idea comprises:
displaying a new trade idea interface;
entering trade idea description information; and
associating the trade idea with one or more financial products, where each financial product is identified by an identifier in a financial product taxonomy; and
presenting the trade idea, defined by the data grouping, over a computer network to a user by a user interface.

2. The method of claim 1, further comprising:
receiving a request to trade from the user based on the trade idea; and
automatically obtaining a request for quote for the one or more financial products associated with the trade idea.

3. The method of claim 1, wherein presenting the trade idea to the user comprises presenting the user with a current price for the one or more financial products associated with the trade idea.

4. The method of claim 3 further comprising maintaining presentation of an up-to-date current price for the one or more financial products.

5. The method of claim 2 further comprising:
completing a trade for the financial product associated with the trade idea;
storing information about the completed trade in the database system, the information including information about one or more of: the trade idea, a trader who created the trade idea, research on which the trade idea was based, and a researcher who published the research.

6. The method of claim 5 further comprising:
receiving additional information related to the one or more trade ideas associated with the completed trade and research on which the trade ideas were based; and
automatically updating the stored information about the completed trade with the additional information.

7. The method of claim 1, the creation of a data grouping for the new trade idea further comprising:
entering trade idea tag data for classifying the trade idea.

8. The method of claim 1, the creation of a data grouping for the new trade idea further comprising:
associating the trade idea with an expiry time.

9. The method of claim 1 wherein the new trade idea is based on research, the creation of a data grouping for the new trade idea further comprising:
associating the trade idea with one or both of the research and a researcher who published the research.

10. The method of claim 1 wherein the trade idea is created by a trader, the creation of a data grouping for the new trade idea further comprising:
associating the trade idea with the trader.

11. The method claim 1 wherein presenting the trade idea to the user comprises:
presenting the user with a list of financial products available for trading;
indicating a financial product having a trade idea associated with it;
receiving a selection of the financial product having a trade idea associated with it; and
presenting the associated trade idea to the user.

12. The method of claim 1 wherein the creation of a data grouping for the new trade idea further comprises:
associating meta information with the trade idea; and
presenting the trade idea to the user comprises:
receiving a search request from a user; and
presenting the user with a trade idea having meta information that matches the search request.

13. The method of claim 12 wherein the meta information comprises one or more of a classification, a textual description, a sound recording, a transcription of a sound recording, a video recording, and a transcription of a video recording.

14. The method claim 1 wherein presenting the trade idea to the user further comprises:
receiving market data about financial products;
identifying the market data for the financial product associated with the trade idea;
using a market data taxonomy, converting the identified market data to a format for presentation to the user; and
presenting the converted market data to the user with the trade idea.

15. A system for facilitating trade idea utilization, comprising:
one or more processors;
a computer readable medium in communication with the one or more processors, wherein the computer readable medium stores instructions that when executed by the one or more processors cause the one or more processors to:
receive an input and to create a data grouping for a new trade idea based on the input, the data grouping comprising:
trade idea description information; and
one or more identifiers from a financial product taxonomy, the one or more identifiers identifying a respective financial product associated with the trade idea; and
generate a user interface configured to present the trade idea to a user based on the data grouping; and
a storage device for storing a link between the trade idea and the one or more financial products associated with the trade idea.

16. The system of claim 15, wherein the computer readable medium further comprises instructions that when executed by the one or more processors cause the one or more processors to:
receive a request to trade from the user based on the trade idea; and
automatically obtain a request for quote for the one or more financial products associated with the trade idea.

17. The system of claim 15, wherein the user interface is further configured to present the user with a current price for the one or more financial products associated with the trade idea.

18. The system of claim 17, wherein the user interface is further configured to maintain presentation of an up-to-date current price for the one or more financial products.

19. The system of claim 16 wherein the storage is further configured to:
store information about a completed trade, the information including information regarding one or more of: the trade idea, a trader who provided the input to create the trade idea, research on which the trade idea was based, and a researcher who published the research.

20. The system of claim 19 wherein the computer readable medium further comprises instructions that when executed by the one or more processors cause the one or more processors to receive additional information related to the one or more trade ideas associated with the completed trade and research on which the trade ideas were based and to automatically update the stored information about the completed trade in the storage with the additional information.

21. The system of claim 15 wherein the data grouping further comprises:
trade idea tag data for classifying the trade idea.

22. The system of claim 15 wherein the data grouping further comprises:
a trade idea expiry time.

23. The system of claim 15 wherein the new trade idea is based on research and the data grouping further comprises:
a link between the trade idea and one or both of the research and a researcher who published the research.

24. The system of claim 15 wherein the input is received from a trader and the data grouping further comprises:
a link between the trade idea and the trader.

25. The system of claim 15 wherein the user interface is further configured to:
present the user with a list of financial products available for trading;
indicate a financial product having a trade idea associated with it;
receive a selection of the financial product having a trade idea associated with it; and
present the associated trade idea to the user.

26. The system of claim 15 wherein the data grouping further comprises:
meta information with the trade idea; and
wherein the user interface is further configured to:
receive a search request from a user; and
wherein the apparatus further comprise:
a search module configured to identify one or more trade ideas having meta information that matches the search request and to provide the one or more identified trade ideas to the user interface for presentation to the user.

27. The system of claim 26 wherein the meta information comprises one or more of a classification, a textual description, a sound recording, a transcription of a sound recording, a video recording, and a transcription of a video recording.

28. The system of claim 15 wherein the computer readable medium further comprises instructions that when executed by the one or more processors cause the one or more processors to:
receive market data about financial products;
identify the market data for the financial product associated with the trade idea; and
using a market data taxonomy, convert the identified market data to a format used by the user interface;
and wherein the user interface is further configured to:
present the converted market data to the user together with the trade idea.

29. An system for facilitating selection of a financial product asset class, comprising:
one or more processors; and
a storage device in communication with the one or more processors, the storage device storing instructions adapted to be executed by the one or more processors to:
generate a user interface, the user interface configured to display information relating to financial products and to receive a user selection of a financial product asset class;
receive market data from a plurality of information sources, each information source providing market data for financial products in one or more asset classes; and
convert the market data for the selected asset class into a format used by the user interface for use in displaying the information.

30. The system of claim 29 wherein the user interface is further configured to receive a user selection of a customised asset class comprising a plurality of different asset classes and wherein the conversion module is configured to convert the market data for each of the asset classes that make up the custom asset class.

31. The system of claim 29 wherein the user interface includes a plurality of user interface elements configured to display the information relating to financial products, each element being consistent across asset classes, the information content of element depending upon the selected asset class.

32. The system of claim 29 wherein the one or more processors are programmed to use an ontology specifying relationships between market data received from each of the plurality of information sources and the converted market data.

33. The system of claim 32 wherein the ontology comprises a taxonomy specifying the format used by the user interface.

34. A method for facilitating selection of a financial product asset class, comprising:
generating, using a computer system, a user interface configured to display information relating to financial products and to receive a user selection of a financial product asset class, wherein the information relating to the financial products is stored in a database;
receiving, by the computer system, market data from a plurality of information sources, each information source providing market data for financial products in one or more asset classes; and
converting, by the computer system, the market data for the selected asset class into a format used by the user interface for use in displaying the information.

35. The method of claim 34 further comprising:
receiving at the user interface a user selection of a customised asset class comprising a plurality of different asset classes; and
converting the market data for each of the asset classes that make up the custom asset class.

36. The method of claim 34 wherein generating the user interface comprises:
generating a plurality of user interface elements configured to display the information relating to financial products, the elements being consistent across asset classes; and
modifying the information content of each element depending upon the selected asset class.

37. The method of claim 34 wherein the market data is converted using an ontology specifying relationships between market data received from each of the plurality of information sources and the converted market data.

38. The method of claim 37 wherein the ontology comprises a taxonomy specifying the format used by the user interface.

39. A system for use in trading financial products, comprising:
a storage device storing:
a plurality of investor accounts for use in accessing the system, each account associated with a different investor and identifying an importance measure of the investor to a financial trading company; and
a plurality of trade ideas, each trade idea published by the financial trading company and proposing a trade to be made of one or more financial products; and
instructions adapted to be executed by a processor to generate a user interface, the user interface configured to:
receive a login of an investor;
display one or more trade ideas selected from the plurality of trade ideas stored in the storage based upon the importance measure of the investor; and
provide one or more communication options enabling the investor to contact a representative of the financial trading company based upon the importance measure of the investor.

40. The system of claim 39 wherein the one or more communication options are selected from a list comprising: instant message, electronic mail, and request telephone call.

41. The system of claim 39 wherein each investor account further identifies one or more representatives of the trading company that are contactable by the investor.

42. A method for facilitating the trading of financial products, comprising:
storing, in a storage device:
a plurality of investor accounts for use in accessing the system, each account associated with a different investor and identifying an importance measure of the investor to a financial trading company; and
a plurality of trade ideas, each trade idea published by the financial trading company and proposing a trade to be made of one or more financial products; and
generating, using a computer system in communication with the storage device, a user interface, the user interface configured to:
receive a login of an investor;
display one or more trade ideas selected from the plurality of trade ideas stored in the storage based upon the importance measure of the investor; and
provide one or more communication options enabling the investor to contact a representative of the financial trading company based upon the importance measure of the investor.

43. The method of claim 42 wherein the one or more communication options are selected from a list comprising: instant message, electronic mail, and request telephone call.

44. The method of claim 42 wherein each investor account further identifies one or more representatives of the trading company that are contactable by the investor.

45. A system for facilitating the trade of financial products, comprising:
a plurality of sources of market data, each source of market data providing information about a plurality of financial products and identifying each financial product with an identifier particular to that source of market data;
one or more processors programmed to generate a user interface, the user interface capable of displaying a trading interface for use in trading a financial product and configured to receive a user input of an identifier for a financial product;
a storage device storing information about each of a plurality of financial products, the information comprising each of the particular identifiers used for the financial product and data for creating a link to a trading interface for trading the financial product; and
wherein the one or more processors are further programmed to automatically convert the received user input of an identifier for a financial product into a link to the trading interface for trading the financial product.
